(19) United States
(12) Patent Application Publication
(10) Pub. No.: US 2025/0158786 A1
(43) Pub. Date: May 15, 2025

(54) METHODS AND APPARATUSES FOR HARQ-ACK CODEBOOK DETERMINATION PER DCI

(71) Applicant: Lenovo (Beijing) Limited, Beijing (CN)

(72) Inventors: Haipeng Lei, Beijing (CN); Yu Zhang, Beijing (CN)

(73) Assignee: Lenovo (Beijing) Limited, Beijing (CN)

(21) Appl. No.: 18/839,016

(22) PCT Filed: Feb. 18, 2022
(86) PCT No.: PCT/CN2022/076938

§ 371 Date: Aug. 15, 2024

(51) Int. Cl. H04L 5/00; H04L 1/1812; H04L 1/1829; H04W 72/1273; H04W 72/232

(52) U.S. Cl. CPC H04L 5/0055; H04L 1/1861; H04W 72/1273; H04W 72/232; H04L 1/1812

(57) ABSTRACT

The present disclosure relates to methods and apparatuses for HARQ-ACK codebook determination per DCI. According to some embodiments of the disclosure, a UE ma: receive a plurality of DCI formats, wherein each of the plurality of DCI formats schedules one or more PDSCH transmissions on one or more carriers, and the plurality of DCI formats indicates a same slot for transmitting a HARQ-ACK codebook; divide the plurality of DCI formats into at least two sets, wherein a first set of the at least two sets comprises all first type DCI formats of the plurality of DCI formats and a second set of the at least two sets comprises all second type DCI formats of the plurality of DCI formats, wherein each first type DCI format requires a single HARQ-ACK information bit and each second type DCI format requires more than one HARQ-ACK information bit, and wherein DAIs of the first type DCI formats are counted independently from those of the second type DCI formats; generate a first HARQ-ACK sub-codebook comprising HARQ-ACK information bits for DCI formats in the first set; generate a second HARQ-ACK sub-codebook comprising HARQ-ACK information bits for DCI formats in the second set; and transmit the HARQ-ACK codebook comprising the first HARQ-ACK sub-codebook and the second HARQ-ACK sub-codebook.

### TECHNICAL FIELD

The present disclosure relates to wireless communication technology, and more particularly to methods and apparatuses for hybrid automatic repeat request acknowledge (HARQ-ACK) codebook determination per downlink control information (DCI).

### BACKGROUND OF THE INVENTION

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems.

In a wireless communication system, a base station (BS) may transmit data signals to user equipment (UE) via a physical downlink shared channel (PDSCH). The PDSCH transmission to the UE may be dynamic PDSCH or semi-persistent scheduling (SPS) PDSCH. In dynamic scheduling, a BS may transmit, to a UE, downlink control information (DCI) (e.g., DCI format 1_0 or DCI format 1_1) via a corresponding physical downlink control channel (PDCCH). In SPS, a PDSCH transmission is configured to a UE by a BS through higher layer signaling, such as, for example, radio resource control (RRC) signaling. A DCI format with the size of each field of the DCI format is predefined in a standard irrespective of an RRC configuration may be referred to as a fallback DCI format, e.g., DCI format 0_0, and DCI format 1_0. A DCI format with the size of at least one field of the DCI format dependent on an RRC configuration may be referred to as a non-fallback DCI format, e.g., DCI format 0_1, DCI format 1_1, DCI format 0_2, DCI format 1_2, etc.

A UE may transmit hybrid automatic repeat request acknowledgement (HARQ-ACK) feedback (e.g., included in a HARQ-ACK codebook) corresponding to PDSCH transmissions through a physical uplink shared channel (PUSCH) or physical uplink control channel (PUCCH).

There is a need for HARQ-ACK feedback determination in a wireless communication system.

### SUMMARY

Some embodiments of the present disclosure provide a UE, which comprises: a transceiver; and a processor coupled to the transceiver, wherein the processor is configured to: receive a plurality of DCI formats, wherein each of the plurality of DCI formats schedules one or more physical downlink shared channel (PDSCH) transmissions on one or more carriers, and the plurality of DCI formats indicates a same slot for transmitting a HARQ-ACK codebook; and divide the plurality of DCI formats into at least two sets, wherein a first set of the at least two sets comprises all first type DCI formats of the plurality of DCI formats and a second set of the at least two sets comprises all second type DCI formats of the plurality of DCI formats, wherein each first type DCI format requires a single HARQ-ACK information bit and each second type DCI format requires more than one HARQ-ACK information bit, and wherein downlink assignment indicators (DAIs) of the first type DCI formats are counted independently from those of the second type DCI formats; generate a first HARQ-ACK sub-codebook comprising HARQ-ACK information bits for DCI formats in the first set; generate a second HARQ-ACK sub-codebook comprising HARQ-ACK information bits for DCI formats in the second set; and transmit the HARQ-ACK codebook comprising the first HARQ-ACK sub-codebook and the second HARQ-ACK sub-codebook.

In some embodiments, the first type DCI format is from a group including one or more of the following: a fallback DCI format; or a non-fallback DCI format transmitted on a carrier not configured with a code block group (CBG) based (re) transmission, wherein: the carrier is configured with a time domain resource allocation (TDRA) table with each entry indicating a single start and length indicator value (SLIV); the carrier is configured with a TDRA table with at least one entry indicating a plurality of SLIVs and a single PDSCH is scheduled by the non-fallback DCI format; a plurality of PDSCHs on a plurality of carriers is schedulable by the non-fallback DCI and a single PDSCH is scheduled by the non-fallback DCI format; a single PDSCH is schedulable by the non-fallback DCI; or the carrier is configured with a maximum of two transport blocks (TBs) per PDSCH and spatial bundling is applied.

In some embodiments, the second type DCI format is from a group including one or more of the following: a non-fallback DCI format transmitted on a carrier configured with CBG based (re) transmission, or a carrier configured with a TDRA table with at least one entry indicating a plurality of start and length indicator values (SLIVs) and at least two PDSCHs are scheduled by the non-fallback DCI format, or a carrier configured with a maximum of two TBs per PDSCH and no spatial bundling is applied; or a non-fallback DCI which schedules at least two PDSCHs on at least one carrier.

In some embodiments, to generate the second HARQ-ACK sub-codebook, the processor is configured to: generate HARQ-ACK information bits for a DCI format in the second set; wherein in response to the number of PDSCHs scheduled by the DCI format being equal to 1, the number of the generated HARQ-ACK information bits for the DCI format is equal to a configured maximum number of code block groups (CBGs) per transport block (TB); or wherein in response to the number of PDSCHs scheduled by the DCI format being greater than 1, the number of the generated HARQ-ACK information bits for the DCI format is equal to a configured maximum number of PDSCHs schedulable by a DCI format.

In some embodiments, the processor is further configured to determine a unified number of HARQ-ACK information bits per second type DCI format in the second set.

In some embodiments, the unified number is configured by RRC signaling; wherein the unified number is determined based on a configured maximum number of PDSCHs schedulable by a DCI format and a configured maximum number of CBGs per TB; or wherein the unified number is predefined.

In some embodiments, determining the unified number based on the configured maximum number of PDSCHs schedulable by a DCI format and the configured maximum number of CBGs per TB comprises determining that the value of the unified number is equal to the minimum value or the maximum value of the configured maximum number of PDSCHs schedulable by a DCI format and the configured maximum number of CBGs per TB.

In some embodiments, to generate the second HARQ-ACK sub-codebook, the processor is configured to: generate HARQ-ACK information bits for a DCI format in the second set; and in response to the number of the generated HARQ-ACK information bits for the DCI format being greater than the unified number, perform HARQ-ACK bundling to align the generated HARQ-ACK information bits with the unified number, or in response to the number of the generated HARQ-ACK information bits for the DCI format being less than the unified number, perform HARQ-ACK padding to align the generated HARQ-ACK information bits with the unified number.

In some embodiments, the processor is further configured to: receive a SPS PDSCH; and transmit HARQ-ACK feedback for the SPS PDSCH in the HARQ-ACK codebook, wherein the HARQ-ACK feedback for the SPS PDSCH is placed at a predefined position of the first HARQ-ACK sub-codebook or the HARQ-ACK codebook; or wherein the HARQ-ACK feedback for the SPS PDSCH is placed at a predefined position of the second HARQ-ACK sub-codebook with the number of bits of the HARQ-ACK feedback for the SPS PDSCH aligned with a unified number of HARQ-ACK information bits per second type DCI format in the second set.

In some embodiments, the second type DCI format is from a group including one or more of the following: a non-fallback DCI format transmitted on a carrier configured with a TDRA table with at least one entry indicating a plurality of start and length indicator values (SLIVs) and at least two PDSCHs are scheduled by the non-fallback DCI format, or a non-fallback DCI which schedules at least two PDSCHs on at least one carrier.

In some embodiments, the at least two sets further include a third set comprising all third type DCI formats of the plurality of DCI formats, and wherein the third type DCI format comprises a non-fallback DCI format that schedules a single PDSCH and is transmitted on a carrier configured with CBG based (re) transmission.

In some embodiments, the number of HARQ-ACK information bits per second type DCI format is determined based on a configured maximum number of PDSCHs schedulable by a second type DCI format, and the number of HARQ-ACK information bits per third type DCI format is determined based on a configured maximum number of CBGs per TB.

In some embodiments, in response to the number of HARQ-ACK information bits per second type DCI format equal to that per third type DCI format, DAIs of the third type DCI formats are counted together with those of the second type DCI formats and the second HARQ-ACK sub-codebook further comprises HARQ-ACK information bits for DCI formats in the third set; or in response to the number of HARQ-ACK information bits per second type DCI format unequal to that per third type DCI format, DAIs of the third type DCI formats are counted independently from those of the second type DCI formats and the HARQ-ACK codebook further comprises a third HARQ-ACK sub-codebook comprising HARQ-ACK information bits for DCI formats in the third set.

In some embodiments, the second type DCI format comprises a non-fallback DCI format transmitted on a carrier configured with a TDRA table with at least one entry indicating a plurality of start and length indicator values (SLIVs) and at least two PDSCHs are scheduled on a same carrier by the non-fallback DCI format.

In some embodiments, the at least two sets further include a third set comprising all third type DCI formats of the plurality of DCI formats and a fourth set comprising all fourth type DCI formats of the plurality of DCI formats; and wherein the third type DCI format comprises a non-fallback DCI format that schedules at least two PDSCHs on at least two carriers, and the fourth type DCI format comprises a non-fallback DCI format that schedules a single PDSCH and is transmitted on a carrier configured with CBG based (re) transmission.

In some embodiments, the number of HARQ-ACK information bits per second type DCI format is determined based on a configured maximum number of PDSCHs schedulable on a single serving cell by a second type DCI format, the number of HARQ-ACK information bits per third type DCI format is determined based on a configured maximum number of PDSCHs schedulable on a plurality of serving cells by a third type DCI format, and the number of HARQ-ACK information bits per fourth type DCI format is determined based on a configured maximum number of CBGs per TB.

In some embodiments, in response to the number of HARQ-ACK information bits per third type DCI format being equal to the number of HARQ-ACK information bits per second type DCI format, DAIs of the third type DCI formats are counted with those of the second type DCI formats, and the second HARQ-ACK sub-codebook further comprises HARQ-ACK information bits for DCI formats in the third set; in response to the number of HARQ-ACK information bits per fourth type DCI format being equal to the number of HARQ-ACK information bits per second type DCI format, DAIs of the fourth type DCI formats are counted with those of the second type DCI formats, and the second HARQ-ACK sub-codebook further comprises HARQ-ACK information bits for DCI formats in the fourth set; in response to the number of HARQ-ACK information bits per third type DCI format being unequal to that per second type DCI format, DAIs of the third type DCI formats are counted independently from those of the second type DCI formats, and the HARQ-ACK codebook further comprises a third HARQ-ACK sub-codebook comprising HARQ-ACK information bits for DCI formats in the third set; in response to the number of HARQ-ACK information bits per fourth type DCI format being unequal to that per second type DCI format, DAIs of the fourth type DCI formats are counted independently from those of the second type DCI formats and the HARQ-ACK codebook further comprises a fourth HARQ-ACK sub-codebook comprising HARQ-ACK information bits for DCI formats in the fourth set; in response to the number of HARQ-ACK information bits per third type DCI format being equal to that per fourth type DCI format but unequal to that per second type DCI format, DAIs of the third and fourth type DCI formats are counted together and independently from those of the second type DCI formats, and the HARQ-ACK codebook further comprises a third HARQ-ACK sub-codebook comprising HARQ-ACK information bits for DCI formats in the third and fourth sets; in response to the number of HARQ-ACK information bits per second type DCI format, the number of HARQ-ACK information bits per third type DCI format, the number of HARQ-ACK information bits per fourth type DCI format being different from each other. DAIs of the second, third and fourth type DCI formats are counted independently from each other, and the HARQ-ACK codebook further comprises a third HARQ-ACK sub-codebook comprising HARQ-ACK information bits for DCI formats in the third set and a fourth HARQ-ACK sub-codebook comprising HARQ-ACK information bits for DCI formats in the fourth set; or any combination thereof.

In some embodiments, a first DCI format of the plurality of DCI formats schedules a plurality of PDSCHs in a plurality of time units on a single carrier. HARQ-ACK information bits for the plurality of PDSCHs scheduled by the first DCI format are arranged according to the plurality of time units.

In some embodiments, a first DCI format of the plurality of DCI formats schedules a plurality of PDSCHs on a plurality of carriers. HARQ-ACK information bits for the plurality of PDSCHs scheduled by the first DCI format are arranged according to indexes of the plurality of carriers.

Another embodiment of the present disclosure provides a UE, which comprises: a transceiver; and a processor coupled to the transceiver, wherein the processor is configured to: receive a plurality of DCI formats, wherein each of the plurality of DCI formats schedules one or more physical downlink shared channel (PDSCH) transmissions on one or more carriers, and the plurality of DCI formats indicates the same slot for transmitting a HARQ-ACK codebook, and wherein each of the plurality of DCI formats requires a unified number of HARQ-ACK information bits; and transmit the HARQ-ACK codebook comprising HARQ-ACK information bits corresponding to each of the plurality of DCI formats.

In some embodiments, DAIs of the plurality of DCI formats are counted together and the HARQ-ACK information bits for the plurality of DCI formats are arranged according to the DAIs of the plurality of DCI formats.

In some embodiments, the unified number is configured by RRC signaling or determined based on a configured maximum number of PDSCHs schedulable by a DCI format and a configured maximum number of CBGs per TB; or wherein the unified number is predefined.

In some embodiments, the value of the unified number is equal to the minimum value or the maximum value of the configured maximum number of PDSCHs schedulable by a DCI format and the configured maximum number of CBGs per TB.

In some embodiments, to generate the HARQ-ACK codebook, the processor is further configured to: generate HARQ-ACK information bits for a DCI format of the plurality of DCI formats; in response to the number of the generated HARQ-ACK information bits for the DCI format being greater than the unified number, perform HARQ-ACK bundling to align the generated HARQ-ACK information bits with the unified number, or in response to the number of the generated HARQ-ACK information bits for the DCI format being less than the unified number, perform HARQ-ACK padding to align the generated HARQ-ACK information bits with the unified number.

In some embodiments, a first DCI format of the plurality of DCI formats schedules a plurality of PDSCHs in a plurality of time units on a single carrier. HARQ-ACK information bits for the plurality of PDSCHs scheduled by the first DCI format are arranged according to the plurality of time units.

In some embodiments, a first DCI format of the plurality of DCI formats schedules a plurality of PDSCHs on a plurality of carriers. HARQ-ACK information bits for the plurality of PDSCHs scheduled by the first DCI format are arranged according to indexes of the plurality of carriers.

Another embodiment of the present disclosure provides a BS, which comprises: a transceiver; and a processor coupled to the transceiver, wherein the processor is configured to: transmit, to a user equipment (UE), a plurality of DCI formats, wherein each of the plurality of DCI formats schedules one or more physical downlink shared channel (PDSCH) transmissions on one or more carriers, and the plurality of DCI formats indicates a same slot for transmitting a HARQ-ACK codebook; and receive, from the UE, the HARQ-ACK codebook comprising a first HARQ-ACK sub-codebook and a second HARQ-ACK sub-codebook, wherein the plurality of DCI formats includes at least two sets, wherein a first set of the at least two sets comprises all first type DCI formats of the plurality of DCI formats and a second set of the at least two sets comprises all second type DCI formats of the plurality of DCI formats, wherein each first type DCI format requires a single HARQ-ACK information bit and each second type DCI format requires more than one HARQ-ACK information bit, and wherein DAIs of the first type DCI formats are counted independently from those of the second type DCI formats; wherein the first HARQ-ACK sub-codebook comprises HARQ-ACK information bits for DCI formats in the first set; and wherein the second HARQ-ACK sub-codebook comprises HARQ-ACK information bits for DCI formats in the second set.

In some embodiments, the first type DCI format is from a group including one or more of the following: a fallback DCI format; or a non-fallback DCI format transmitted on a carrier not configured with CBG based (re) transmission, wherein: the carrier is configured with a TDRA table with each entry indicating a SLIV; the carrier is configured with a TDRA table with at least one entry indicating a plurality of SLIVs and a single PDSCH is scheduled by the non-fallback DCI format; a plurality of PDSCHs on a plurality of carriers is schedulable by the non-fallback DCI and a single PDSCH is scheduled by the non-fallback DCI format; a single PDSCH is schedulable by the non-fallback DCI; or the carrier is configured with a maximum of two TBs per PDSCH and spatial bundling is applied.

In some embodiments, the second type DCI format is from a group including one or more of the following: a non-fallback DCI format transmitted on a carrier configured with CBG based (re) transmission, or a carrier configured with a TDRA table with at least one entry indicating a plurality of start and length indicator values (SLIVs) and at least two PDSCHs are scheduled by the non-fallback DCI format, or a carrier configured with a maximum of two TBs per PDSCH and no spatial bundling is applied; or a non-fallback DCI which schedules at least two PDSCHs on at least one carrier.

In some embodiments, the processor is further configured to determine a unified number of HARQ-ACK information bits per second type DCI format in the second set.

In some embodiments, the unified number is determined based on a configured maximum number of PDSCHs schedulable by a DCI format and a configured maximum number of CBGs per TB; wherein the unified number is predefined; or wherein the processor is further configured to transmit the unified number to the UE via RRC signaling.

In some embodiments, determining the unified number based on the configured maximum number of PDSCHs schedulable by a DCI format and the configured maximum number of CBGs per TB comprises determining that the value of the unified number is equal to the minimum value or the maximum value of the configured maximum number of PDSCHs schedulable by a DCI format and the configured maximum number of CBGs per TB.

In some embodiments, the processor is further configured to: transmit, to the UE, a SPS PDSCH; and receive HARQ-ACK feedback for the SPS PDSCH in the HARQ-ACK codebook, wherein the HARQ-ACK feedback for the SPS PDSCH is placed at a predefined position of the first HARQ-ACK sub-codebook or the HARQ-ACK codebook; or wherein the HARQ-ACK feedback for the SPS PDSCH is placed at a predefined position of the second HARQ-ACK sub-codebook with the number of bits of the HARQ-ACK feedback for the SPS PDSCH aligned with a unified number of HARQ-ACK information bits per second type DCI format in the second set.

In some embodiments, the second type DCI format is from a group including one or more of the following: a non-fallback DCI format transmitted on a carrier configured with a TDRA table with at least one entry indicating a plurality of start and length indicator values (SLIVs) and at least two PDSCHs are scheduled by the non-fallback DCI format, or a non-fallback DCI which schedules at least two PDSCHs on at least one carrier.

In some embodiments, the at least two sets further include a third set comprising all third type DCI formats of the plurality of DCI formats, and wherein the third type DCI format comprises a non-fallback DCI format that schedules a single PDSCH and is transmitted on a carrier configured with CBG based (re) transmission.

In some embodiments, the number of HARQ-ACK information bits per second type DCI format is determined based on a configured maximum number of PDSCHs schedulable by a second type DCI format, and the number of HARQ-ACK information bits per third type DCI format is determined based on a configured maximum number of CBGs per TB.

In some embodiments, in response to the number of HARQ-ACK information bits per second type DCI format equal to that per third type DCI format, DAIs of the third type DCI formats are counted together with those of the second type DCI formats and the second HARQ-ACK sub-codebook further comprises HARQ-ACK information bits for DCI formats in the third set; or in response to the number of HARQ-ACK information bits per second type DCI format unequal to that per third type DCI format, DAIs of the third type DCI formats are counted independently from those of the second type DCI formats and the HARQ-ACK codebook further comprises a third HARQ-ACK sub-codebook comprising HARQ-ACK information bits for DCI formats in the third set.

In some embodiments, the second type DCI format comprises a non-fallback DCI format transmitted on a carrier configured with a TDRA table with at least one entry indicating a plurality of start and length indicator values (SLIVs) and at least two PDSCHs are scheduled on a same carrier by the non-fallback DCI format.

In some embodiments, the at least two sets further include a third set comprising all third type DCI formats of the plurality of DCI formats and a fourth set comprising all fourth type DCI formats of the plurality of DCI formats; and wherein the third type DCI format comprises a non-fallback DCI format that schedules at least two PDSCHs on at least two carriers, and the fourth type DCI format comprises a non-fallback DCI format that schedules a single PDSCH and is transmitted on a carrier configured with CBG based (re) transmission.

In some embodiments, the number of HARQ-ACK information bits per second type DCI format is determined based on a configured maximum number of PDSCHs schedulable on a single serving cell by a second type DCI format, the number of HARQ-ACK information bits per third type DCI format is determined based on a configured maximum number of PDSCHs schedulable on a plurality of serving cells by a third type DCI format, and the number of HARQ-ACK information bits per fourth type DCI format is determined based on a configured maximum number of CBGs per TB.

In some embodiments, in response to the number of HARQ-ACK information bits per third type DCI format being equal to the number of HARQ-ACK information bits per second type DCI format, DAIs of the third type DCI formats are counted with those of the second type DCI formats, and the second HARQ-ACK sub-codebook further comprises HARQ-ACK information bits for DCI formats in the third set; in response to the number of HARQ-ACK information bits per fourth type DCI format being equal to the number of HARQ-ACK information bits per second type DCI format, DAIs of the fourth type DCI formats are counted with those of the second type DCI formats, and the second HARQ-ACK sub-codebook further comprises HARQ-ACK information bits for DCI formats in the fourth set; in response to the number of HARQ-ACK information bits per third type DCI format being unequal to that per second type DCI format, DAIs of the third type DCI formats arc counted independently from those of the second type DCI formats, and the HARQ-ACK codebook further comprises a third HARQ-ACK sub-codebook comprising HARQ-ACK information bits for DCI formats in the third set; in response to the number of HARQ-ACK information bits per fourth type DCI format being unequal to that per second type DCI format, DAIs of the fourth type DCI formats are counted independently from those of the second type DCI formats, and the HARQ-ACK codebook further comprises a fourth HARQ-ACK sub-codebook comprising HARQ-ACK information bits for DCI formats in the fourth set; in response to the number of HARQ-ACK information bits per third type DCI format being equal to that per fourth type DCI format but unequal to that per second type DCI format, DAIs of the third and fourth type DCI formats are counted together and independently from those of the second type DCI formats, and the HARQ-ACK codebook further comprises a third HARQ-ACK sub-codebook comprising HARQ-ACK information bits for DCI formats in the third and fourth sets; in response to the number of HARQ-ACK information bits per second type DCI format, the number of HARQ-ACK information bits per third type DCI format, the number of HARQ-ACK information bits per fourth type DCI format being different from each other, DAIs of the second, third and fourth type DCI formats are counted independently from each other, and the HARQ-ACK codebook further comprises a third HARQ-ACK sub-codebook comprising HARQ-ACK information bits for DCI formats in the third set and a fourth HARQ-ACK sub-codebook comprising HARQ-ACK information bits for DCI formats in the fourth set; or any combination thereof.

In some embodiments, a first DCI format of the plurality of DCI formats schedules a plurality of PDSCHs in a plurality of time units on a single carrier. HARQ-ACK information bits for the plurality of PDSCHs scheduled by the first DCI format are arranged according to the plurality of time units.

In some embodiments, a first DCI format of the plurality of DCI formats schedules a plurality of PDSCHs on a plurality of carriers. HARQ-ACK information bits for the plurality of PDSCHs scheduled by the first DCI format are arranged according to indexes of the plurality of carriers.

Yet another embodiment of the present disclosure provides a BS, which comprises: a transceiver; and a processor coupled to the transceiver, wherein the processor is configured to: transmit, to a user equipment (UE), a plurality of DCI formats, wherein each of the plurality of DCI formats schedules one or more physical downlink shared channel (PDSCH) transmissions on one or more carriers, and the plurality of DCI formats indicates a same slot for transmitting a HARQ-ACK codebook, and wherein each of the plurality of DCI formats requires a unified number of HARQ-ACK information bits; and receive, from the UE, the HARQ-ACK codebook comprising HARQ-ACK information bits corresponding to each of the plurality of DCI formats.

In some embodiments, DAIs of the plurality of DCI formats are counted together and the HARQ-ACK information bits for the plurality of DCI formats are arranged according to the DAIs of the plurality of DCI formats.

In some embodiments, the unified number is determined based on a configured maximum number of PDSCHs schedulable by a DCI format and a configured maximum number of CBGs per TB; or wherein the unified number is predefined; or wherein the processor is configured to transmit the unified number to the UE via RRC signaling.

In some embodiments, the value of the unified number is equal to the minimum value or the maximum value of the configured maximum number of PDSCHs schedulable by a DCI format and the configured maximum number of CBGs per TB.

In some embodiments, a first DCI format of the plurality of DCI formats schedules a plurality of PDSCHs in a plurality of time units on a single carrier. HARQ-ACK information bits for the plurality of PDSCHs scheduled by the first DCI format are arranged according to the plurality of time units.

In some embodiments, a first DCI format of the plurality of DCI formats schedules a plurality of PDSCHs on a plurality of carriers. HARQ-ACK information bits for the plurality of PDSCHs scheduled by the first DCI format are arranged according to indexes of the plurality of carriers.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only example embodiments of the disclosure and are not therefore to be considered limiting of its scope.

FIG. 1 illustrates a schematic diagram of a wireless communication system in accordance with some embodiments of the present disclosure.

FIG. 2 illustrates a schematic diagram of a DCI format scheduling a plurality of PDSCH transmissions in accordance with some embodiments of the present disclosure.

FIG. 3 illustrates a schematic diagram of a DCI format scheduling a PDSCH transmission(s) in accordance with some embodiments of the present disclosure.

FIGS. 4A-4D illustrates exemplary HARQ-ACK codebook determination in accordance with some embodiments of the present disclosure.

FIG. 5 illustrates a flow chart of an exemplary procedure of wireless communications in accordance with some embodiments of the present disclosure.

FIG. 6 illustrates a flow chart of an exemplary procedure of wireless communications in accordance with some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the preferred embodiments of the present disclosure, and is not intended to represent the only form in which the present disclosure may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

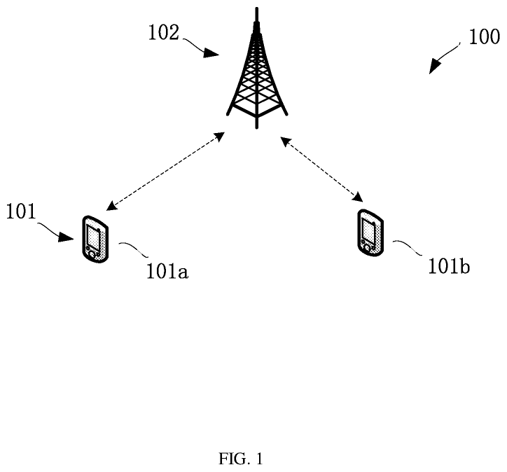

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BS 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with the 5G NR of the 3GPP protocol. For example, BS 102 may transmit data using an OFDM modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

NR supports a wide range of spectrums in different frequency ranges. In the market for 5G Advanced, it is expected that the availability of the spectrum will be increased, which is possibly due to re-farming the bands originally used for previous cellular generation networks. For example, for some low frequency bands of FR1 (e.g., 450 MHz-6000 MHz), the available spectrum bands tend to be more fragmented and scattered with a narrower bandwidth. In addition, for bands of FR2 (24250 MHz-52600 MHz) and some bands of FRI (frequency range 1), the available spectrum may be wider such that an intra-band multi-carrier operation is necessary.

To meet different spectrum needs, it is important to ensure that these fragmented or scattered spectrum bands or spectrums with wider bandwidth are utilized in a more spectrum and power efficient and flexible manner, thereby providing higher throughput and decent coverage in the network.

For example, one motivation is to increase spectrum/power efficiency and flexibility on scheduling data over multiple cells including intra-band cells and inter-band cells. In some examples, scheduling mechanisms may only allow scheduling a single PUSCH or PDSCH on a single cell per a scheduling DCI. As more scattered spectrum bands or spectrums with wider bandwidth become available, it is advisable to allow simultaneous scheduling of multiple cells.

NR is designed to support a max of 16 component carriers (CCs) in the case of CA or a max of 32 CCs in the case of dual connectively (DC). Carrier aggregation (CA) is referred to as spectrum aggregation or bandwidth aggregation, which supports a plurality of carriers for improving data rate. An individual unit frequency bound by CA is referred to as a component carrier (CC). A CC may correspond to a serving cell. CA provides the same effect as the case in which a plurality of bands, which are physically continuous or non-continuous in the frequency domain, are bound and used as a logically large band.

In some embodiments of the present disclosure, in the case of CA, one DCI can schedule at most one carrier by cross-carrier scheduling or self-scheduling. This may require relatively higher signaling overhead for PDCCHs to schedule PDSCHs when, for example, the number of carriers configured for a UE is large. In some embodiments of the present disclosure, it is proposed that a single DCI can be used to schedule a plurality of PDSCHs (or PDSCH transmissions) on a plurality of configured carriers. These embodiments can greatly reduce signaling overhead.

When using a single DCI scheduling multiple PDSCHs on multiple carriers, and the single DCI is missed by the UE, the UE can identify that there is one DCI missing, however, the UE cannot determine the number of carriers scheduled by the missed DCI. Accordingly, the UE cannot determine the size of the HARQ-ACK codebook for the missed DCI, which may render a HARQ-ACK codebook mismatch between the UE and the BS. In other words, the HARQ-ACK codebook generated by the UE may not match what the BS expects.

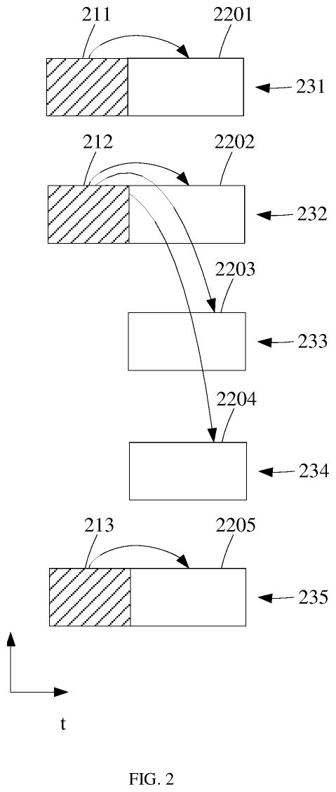

FIG. 2 illustrates a schematic diagram of a DCI format scheduling a plurality of PDSCH transmissions in accordance with some embodiments of the present disclosure.

In some embodiments of the present disclosure, a plurality of CCs (e.g., CCs 231-235 in FIG. 2) may be configured for a UE. It should be understood that the sub-carrier spacing (SCS) of the carriers configured for a UE may be the same or different. Each of the plurality of CCs may correspond to a respective serving cell of the UE. Each serving cell may be associated with a serving cell index. In some examples, the serving cell indexes corresponding to CCs 231-235 may be arranged in an ascending order.

As shown in FIG. 2, instead of using five DCI formats to respectively schedule five PDSCH transmissions (e.g., PDSCH transmissions 2201-2205 in FIG. 2) on the five carriers (e.g., CCs 231-235), a BS may transmit less (e.g., three) DCI formats in a slot (e.g., slot n) to schedule the five PDSCH transmissions on the five carriers.

For example, DCI format #1 in PDCCH 211 may schedule PDSCH transmission 2201 on carrier 231. DCI format #2 in PDCCH 212 may schedule a plurality of PDSCH transmissions, for example, PDSCH transmission 2202 on carrier 232, PDSCH transmission 2203 on carrier 233, and PDSCH transmission 2204 on carrier 234. DCI format #3 in PDCCH 213 may schedule PDSCH transmission 2205 on carrier 235.

Each DCI format may indicate a downlink assignment index (DAI) to facilitate HARQ-ACK feedback for the PDSCH transmission(s) scheduled by the corresponding DCI format.

For example, in some embodiments of the present disclosure, the DCI format may include a DAI (e.g., a counter DAI) to indicate the accumulative number of transmitted DCI formats (or {serving cell, PDCCH monitoring occasion}-pair(s)) for scheduling a dynamic PDSCH transmission, activating semi-persistent scheduling (SPS) PDSCH transmission, releasing SPS PDSCH transmission, or indicating secondary cell (SCell) dormancy, up to the current serving cell and the current PDCCH monitoring occasion. In some embodiments of the present disclosure, the DCI format may also include an additional DAI (e.g., a total DAI) to indicate the total number of transmitted DCI formats (or {serving cell, PDCCH monitoring occasion}-pair(s)) for scheduling a dynamic PDSCH transmission, activating SPS PDSCH transmission, releasing SPS PDSCH transmission, or indicating SCell dormancy, up to the current PDCCH monitoring occasion.

The counter DAI field or total DAI field in a DCI format may include at least two bits, indicating, for example, “00,” “01,” “10,” or “11,” which may be mapped to numeric values of “1,” “2.” “3.” and “4,” respectively. When the value is larger than 4, it shall be modular by 4 so as to be indicated by only two bits. For example, values of 1 and 5 are indicated by “00”, values of 2 and 6 are indicated by “01”, values of 3 and 7 are indicated by “10”, values of 4 and 8 are indicated by “11”, and so on. It should be understood that the values of the parameters in a DCI format mentioned in the context of the subject disclosure are only for illustrative purposes, and should not be construed as limiting the embodiments of the present disclosure.

Still referring to FIG. 2, based on the above definitions, DCI format #1 in PDCCH 211 may indicate a counter DAI indicating the numeric value of “1” and a total DAI indicating the numeric value of “3.” DCI format #2 in PDCCH 212 may indicate a counter DAI indicating the numeric value of “2” and a total DAI indicating the numeric value of “3.” DCI format #3 in PDCCH 213 may indicate a counter DAI indicating the numeric value of “3” and a total DAI indicating the numeric value of “3.”

From the perspective of a UE, when no DCI format is missed, the UE can determine five PDSCH transmissions scheduled by the three DCI formats and may transmit corresponding HARQ-ACK feedback for the five PDSCH transmissions in a HARQ-ACK codebook. For example, assuming that a single HARQ-ACK information bit is required for each PDSCH transmission, the UE may generate HARQ-ACK information bits for PDSCH transmissions 2201-2205 (e.g., bit x1 for PDSCH transmission 2201, bit x2 for PDSCH transmission 2202, bit x3 for PDSCH transmission 2203, bit x4 for PDSCH transmission 2204, and bit b5 for PDSCH transmission 2205) in a HARQ-ACK codebook (e.g., {x1, x2, x3, x4, x5}). Each HARQ-ACK information bit (e.g., x1, x2, x3, x4, or x5) may be either an acknowledgement (ACK) or negative ACK (NACK) information bit. It should be understood that two or more HARQ-ACK information bits (e.g., two or more ACK or NACK information bits) may be required for each PDSCH transmission in some other examples.

When a DCI format (e.g., DCI format #2 in PDCCH 212) scheduling a plurality of PDSCHs is missed, a UE may determine that a DCI is missed based on the received DAIs, for example, the counter DAIs of DCI format #1 and DCI format #3. However, the UE cannot determine how many PDSCHs are scheduled by the missed DCI based on the received DAIs, for example, the total DAIs of DCI format #1 and DCI format #3. In some examples, the UE may assume that the missed DCI schedules a single PDSCH. As a result, the UE may generate a HARQ-ACK codebook including HARQ-ACK feedback (e.g., x1) for PDSCH transmission 2201, HARQ-ACK feedback (e.g., NACK) for the assumed single PDSCH transmission, and HARQ-ACK feedback (e.g., x5) for PDSCH transmission 2205. In other words, the UE may transmit a HARQ-ACK codebook, for example, {x1, NACK, x5} to the BS, which may expect HARQ-ACK feedback corresponding to five transmitted PDSCHs, for example, a HARQ-ACK codebook of {x1, x2, x3, x4, x5}. As a result, a misunderstanding of the HARQ-ACK codebook may happen between the BS and the UE. Moreover, since the HARQ-ACK codebook generated by the UE does not match what the BS expects, the BS may be unable to decode the HARQ-ACK codebook from the UE.

In the above scenario, as long as the number of actually transmitted PDSCHs is unknown to the UE, such misunderstanding between the UE and the BS may happen. Since the BS cannot receive the HARQ-ACK feedback for the transmitted PDSCHs due to the misunderstanding, the BS has to retransmit all the transmitted PDSCHs (in the above case, five PDSCHs have to be retransmitted), which would result in a degradation of downlink performance.

Solutions need to be provided to avoid such misunderstanding of the HARQ-ACK codebook between the UE and the BS. More details on the embodiments of the present disclosure will be illustrated in the following text in combination with the appended drawings.

In the present disclosure, the HARQ-ACK information bits for PDSCHs scheduled in multiple time units (e.g., slots) of a single carrier by a single DCI may be ordered based on the time information (e.g., slot indexes). The HARQ-ACK information bits for PDSCHs scheduled on multiple carriers by a single DCI may be ordered based on the serving cell index.

In some embodiments of the present disclosure, a unified number of HARQ-ACK information bits may be determined for the DCI formats with HARQ-ACK information bits to be multiplexed in the same HARQ-ACK codebook. Although the actual HARQ-ACK information bits for each DCI format may be different, the UE may align the actual HARQ-ACK information bits with the unified number of HARQ-ACK information bits. DAIs of the DCI formats are counted among all the DCI formats with HARQ-ACK information bits to be multiplexed in the same HARQ-ACK codebook.

For example, when a UE is configured with code block group (CBG) based (re) transmission, multiple PDSCHs scheduled by a single DCI format on one or multiple carriers in the same cell group, or any combination thereof, the scheduled PDSCHs may be in different slots on the same carrier or on different carriers, when HARQ-ACK feedback for all the scheduled PDSCHs is to be transmitted in one HARQ-ACK codebook, each DCI format may correspond to a unified number of HARQ-ACK information bits, no matter how many PDSCHs are scheduled by a DCI format, whether the CBG-based (re) transmission is applied to the PDSCH scheduled by the DCI format, or whether maximum 2 TBs can be carried by the PDSCH scheduled by the DCI.

The present disclosure proposes several options for determining the unified number of HARQ-ACK information bits. Hereinafter in the present disclosure, the following parameters are used for clarity:
O, which represents the unified number of HARQ-ACK information bits per DCI format;
N, which represents the configured maximum number of CBGs per TB;
M, which represents the maximum number of PDSCHs which can be scheduled by a single DCI format;
A, which represents the configured maximum number of PDSCHs on the same serving cell which can be scheduled by a single DCI format; and/or
B, which represents the configured maximum number of PDSCHs on multiple serving cells which can be scheduled by a single DCI format.

The UE may determine the unified number of HARQ-ACK information bits for each DCI format, i.e., O, by one of the following options:

Option A1: The unified number of HARQ-ACK information bits per DCI format may be configured by RRC signaling, and the configured number may be 1, 2, 4, 6, or 8.

Option A2: The unified number of HARQ-ACK information bits per DCI format may be determined based on the values of M and N or the values of A, B and N. In some examples, the unified number is equal to the minimum value of M and N, i.e., 0=min (M, N), or the minimum value of A, B and N, i.e., 0=min (A,B,N). In some examples, the unified number is equal to the maximum value of M and N, i.e., 0=max (M, N), or the maximum value of A, B and N, i.e., 0=max (A, B, N). In some examples, the unified number is equal to the average value of M and N, i.e., 0=(M+N)/2, or the average value of A, B and N. i.e., 0=(A+B+N)/2.

Option A3: The unified number of HARQ-ACK information bits per DCI format is predefined, for example, in a standard(s). For example, the unified number may be equal to 1.

In the above options, when the actual number of HARQ-ACK information bits for the PDSCH(s) scheduled by a DCI format is equal to the unified number O, the UE may transmit the HARQ-ACK information bits for the DCI format without a further process of the HARQ-ACK information bits.

When the actual number of HARQ-ACK information bits for the PDSCH(s) scheduled by a DCI format is larger than the unified number O, the UE may perform HARQ-ACK bundling to align with the unified number O. For example, the UE may perform a logic AND operation among the HARQ-ACK information bits for a DCI format, until the total number of the HARQ-ACK information bits for the DCI format equals to the unified number.

When the actual number of HARQ-ACK information bits for the PDSCH(s) scheduled by a DCI format is smaller than the unified number O, the UE may perform HARQ-ACK padding to align with the unified number O. For example, the UE may append padding bits (e.g., NACK bits) to the HARQ-ACK information bits until the total number of the HARQ-ACK information bits for the DCI format equals to the unified number.

For example, when the unified number O and the HARQ-ACK information bits for a DCI format are equal to one, HARQ-ACK bundling is not performed. Otherwise, when the unified number O is equal to one and the HARQ-ACK information bits for a DCI format is larger than one, HARQ-ACK bundling may be performed by a logic AND operation among the HARQ-ACK information bits per DCI format, so that a single HARQ-ACK bit is generated for each DCI format. This bundling operation may be performed for HARQ-ACK information bits for a DCI format as long as the number of the HARQ-ACK information bits is larger than 1. That is, no matter whether the DCI format schedules multiple PDSCHs on one carrier, on multiple carriers in one or more slots, or the scheduled PDSCHs are configured with the same or different maximum numbers of CBGs per TB, there is only one HARQ-ACK information bit for the DCI format in the codebook.

In this way, each DCI format corresponds to O corresponding consecutive bits in the HARQ-ACK codebook.

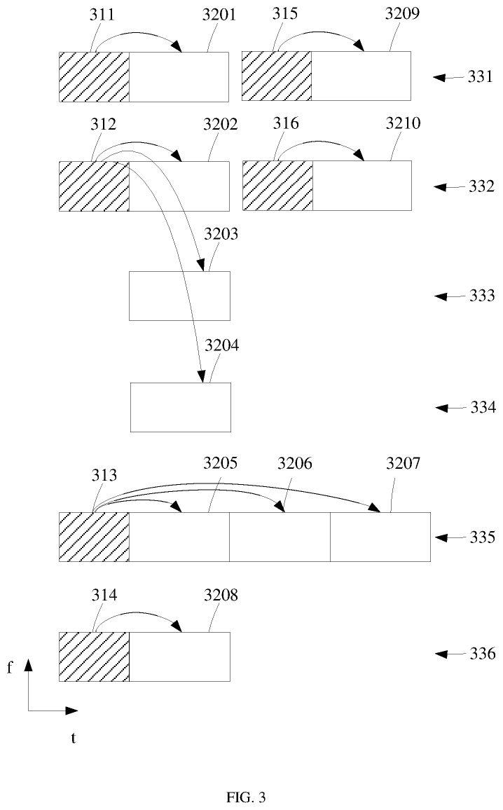

FIG. 3 illustrates a schematic diagram of a DCI format scheduling a PDSCH transmission(s) in accordance with some embodiments of the present disclosure.

In FIG. 3, a plurality of CCs (e.g., six CCs, CCs 331-336 in FIG. 3) may be configured for a UE. Each of the plurality of CCs may correspond to a respective serving cell of the UE. Each serving cell may be associated with a serving cell index. In some examples, the serving cell indexes corresponding to CCs 331-336 may be arranged in an ascending order.

As shown in FIG. 3, the BS may transmit six DCI formats (i.e., DCI format #A1-#A6) in one or more slots (e.g., slot n, slot n+1, and etc.) to schedule ten PDSCH transmissions (PDSCHs 3201, 3202, . . . , 3210) on the six carriers for the UE. All the six DCI formats indicate the same slot for transmitting the HARQ-ACK feedback for the PDSCHs scheduled by all the six DCI formats.

For example, DCI format #A1 in PDCCH 311 may schedule PDSCH transmission 3201 on carrier 331. DCI format #A2 in PDCCH 312 may schedule a plurality of PDSCH transmissions, for example, PDSCH transmission 3202 on carrier 332, PDSCH transmission 3203 on carrier 333, and PDSCH transmission 3204 on carrier 334. DCI format #A3 in PDCCH 313 may also schedule a plurality of PDSCH transmissions, for example, PDSCH transmissions 3205-3207 on carrier 335. DCI format #A4 in PDCCH 314 may schedule PDSCH transmission 3208 on carrier 336. DCI format #A5 in PDCCH 315 may schedule PDSCH transmission 3209 on carrier 331. DCI format #A6 in PDCCH 316 may schedule PDSCH transmission 3210 on carrier 332.

In some examples, one or more DCI formats may be configured with a TB-based (re) transmission (e.g., TB-based transmission, TB-based retransmission, or any combination thereof) or a CBG-based (re) transmission (CBG-based transmission, CBG-based retransmission, or any combination thereof). For example, DCI format #A1 in PDCCH 311 may schedule PDSCH transmission 3201 on carrier 331 with TB-based (re) transmission, DCI format #A4 in PDCCH 314 may schedule PDSCH transmission 3208 on carrier 336 with CBG-based (re) transmission, DCI format #A5 in PDCCH 315 may schedule PDSCH transmission 3209 on carrier 331 with TB-based (re) transmission, and DCI format #A6 in PDCCH 316 may schedule PDSCH transmission 3210 on carrier 332 with TB-based (re) transmission.

It is assumed that HARQ-ACK feedback for transmission 3201 to 3210 is to be transmitted in the same HARQ-ACK codebook. In some embodiments, when a unified number of HARQ-ACK information bits is applied to DCI format #A1-#A6, DAIs of DCI formats #A1-#A6 may be counted together among all DCI formats #A1-#A6. For example, according to the DAI definitions as described with respect to FIG. 2, the counter DAI and total DAI indicated by each DCI format (i.e., DCI format #A1-#A6) are presented in the following table.

TABLE 1

| DCI format | counter DAI | total DAI |
|---|---|---|
| DCI format #A1 in PDCCH 311 | 1 | 4 |
| DCI format #A2 in PDCCH 312 | 2 | 4 |
| DCI format #A3 in PDCCH 313 | 3 | 4 |
| DCI format #A4 in PDCCH 314 | 4 | 4 |
| DCI format #A5 in PDCCH 315 | 5 | 6 |
| DCI format #A6 in PDCCH 316 | 6 | 6 |

The UE may determine the unified number of HARQ-ACK information bits according to one of the above described options and arrange the HARQ-ACK information bits for the DCI formats in a HARQ-ACK codebook according to the DAIs, for example in a predefined order (e.g., an ascending order or a descending order) of the counter DAIs.

When HARQ-ACK feedback for a SPS PDSCH is to be transmitted in the HARQ-ACK codebook, the HARQ-ACK feedback for the SPS PDSCH may be placed at a predefined position (e.g., at the beginning or at the end) of the HARQ-ACK codebook. In some examples, the HARQ-ACK information bits for the SPS PDSCH in the HARQ-ACK codebook are the actual HARQ-ACK information bits for the SPS PDSCH. In some examples the HARQ-ACK information bits for the SPS PDSCH in the HARQ-ACK codebook are determined by aligning the actual HARQ-ACK information bits for the SPS PDSCH with the unified number.

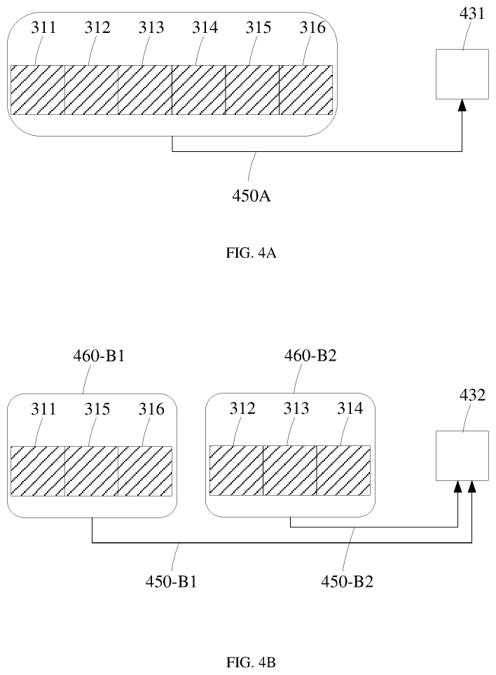

FIG. 4A illustrates exemplary HARQ-ACK codebook determination in accordance with some embodiments of the present disclosure. For example, HARQ-ACK codebook 450A may include HARQ-ACK information bits for PDSCHs scheduled by DCI formats #A1-#A6 in FIG. 3. HARQ-ACK codebook 450A may be transmitted in PUCCH 431.

In one embodiment, when the unified number of HARQ-ACK information bits per DCI is equal to one, then there is one HARQ-ACK information bit for a PDSCH(s) scheduled by each DCI. Bundling may be performed for size alignment. For example, the HARQ-ACK codebook 450A may include {a1, a2, a3, a4, a5, a6}, where
a1 is the HARQ-ACK information bit for PDSCH 3201 scheduled by DCI format #A1 (or the bundled HARQ-ACK information bit for PDSCH 3201 in case of a maximum of two TBs per PDSCH configured on carrier 331);
a2 is the bundled HARQ-ACK information bit for PDSCH 3202, PDSCH 3203 and PDSCH 3204 scheduled by DCI format #A2;
a3 is the bundled HARQ-ACK information bit for PDSCH 3205, PDSCH 3206 and PDSCH 3207 scheduled by DCI format #A3;
a4 is the HARQ-ACK information bit for PDSCH 3208 scheduled by DCI format #A4 (or the bundled HARQ-ACK information bit for PDSCH 3208 in case of a maximum of two TBs per PDSCH configured on carrier 336);
a5 is the HARQ-ACK information bit for PDSCH 3209 scheduled by DCI format #A5 (or the bundled HARQ-ACK information bit for PDSCH 3209 in case of a maximum of two TBs per PDSCH configured on carrier 331); and
a6 is the HARQ-ACK information bit for PDSCH 3210 scheduled by DCI format #A6 (or the bundled HARQ-ACK information bit for PDSCH 3210 in case of a maximum of two TBs per PDSCH configured on carrier 332).

In another embodiment, the unified number of HARQ-ACK information bits per DCI may be more than one, for example, when equal to two, then there are two HARQ-ACK information bits for a PDSCH(s) scheduled by each DCI format. Bundling and NACK padding may be performed for size alignment. For example, the HARQ-ACK codebook 450A may include {b1, b2, b3, b4, b5, b6, b7, b8, b9, b10, b11, b12}, where
b1 and b2 are the HARQ-ACK information bits for PDSCH 3201 scheduled by DCI format #A1. For example, in the case of a maximum of one TB per PDSCH being configured on carrier 331, b1 may be the HARQ-ACK information bit for PDSCH 3201, and b2 may be a NACK bit for aligning the size of HARQ-ACK information bits for PDSCH 3201 to the unified number. In the case of a maximum of two TBs per PDSCH being configured on carrier 331, b1 may be the HARQ-ACK information bit for a first TB on PDSCH 3201, and b2 may be the HARQ-ACK information bit for a second TB on PDSCH 3201.
b3 and b4 are the HARQ-ACK information bits for PDSCH 3202, PDSCH 3203 and PDSCH 3204 scheduled by DCI format #A2.
Assuming that the HARQ-ACK information bits for PDSCH 3202, PDSCH 3203 and PDSCH 3204 are b3202, b3203, and b3204, respectively, and bundling (such as the logic AND operation) may be performed on any two bits among the three bits. For example, b3 may be the bundled bit of b3202 and b3203, and b4 may be b3204. For example, b3 may be b3202 and b4 may be the bundled bit of b3203 and b3204.
b5 and b6 are the HARQ-ACK information bits for PDSCH 3205, PDSCH 3206 and PDSCH 3207 scheduled by DCI format #A3. Similarly, as the determination of b3 and b4, b5 and b6 may be determined by performing a logic AND operation between HARQ-ACK bits for any two PDSCHs (e.g., PDSCH 3205 and PDSCH 3206). For example, b5 may be the bundled bit of the actual HARQ-ACK information bits for PDSCH 3205 and PDSCH 3206, and b6 may be the actual HARQ-ACK bit for PDSCH 3207. For example, b5 may be b3205 and b6 may be the bundled bit of b3206 and b3207.
b7 and b8 are the HARQ-ACK information bits for PDSCH 3208 scheduled by DCI format #A4. As indicated above, DCI format #A4 in PDCCH 314 schedules PDSCH transmission 3208 on carrier 336 with CBG-based (re) transmission. b7 and b8 may correspond to two bundled CBG-level HARQ-ACK bits for PDSCH 3208. For example, assuming that 4 CBG-level HARQ-ACK bits for PDSCH 3208 are generated by the UE, the UE may perform a logic AND operation on the first and second bits to obtain b7, and on the third and fourth bits to obtain b8.
b9 and b10 are the HARQ-ACK information bits for PDSCH 3209 scheduled by DCI format #A5. For example, in the case of a maximum of one TB per PDSCH being configured on carrier 331, b9 may be the HARQ-ACK information bit for PDSCH 3209, and b2 may be a NACK bit for aligning the size of HARQ-ACK information bits for PDSCH 3209 to the unified number. In the case of a maximum of two TBs per PDSCH being configured on carrier 331, b9 may be the HARQ-ACK information bit for a first TB on PDSCH 3209, and b10 may be the HARQ-ACK information bit for a second TB on PDSCH 3209.
b11 and b12 are the HARQ-ACK information bits for PDSCH 3210 scheduled by DCI format #A6. For example, b11 is the HARQ-ACK information bit for PDSCH 3210, and b12 is a NACK bit for aligning the size of HARQ-ACK information bits for DCI format #A6 to the unified number.

In some embodiments of the present disclosure, the unified number of HARQ-ACK information bits per DCI format may only be applied a certain type of DCI format, instead of all of the plurality of DCI formats scheduling PDSCHs with HARQ-ACK feedback to be multiplexed in the same HARQ-ACK codebook.

In some embodiments of the present disclosure, the plurality of DCI formats may be divided into at least two sets, depending on the number of HARQ-ACK information bits for the PDSCH(s) scheduled by the DCI formats.

In some embodiments, the plurality of DCI formats may be divided into two sets (e.g., DCI set #B1 and DCI set #B2). DCI set #B1 may include DCI formats of DCI type #B1 among the plurality of DCI formats. DCI set #B2 may include DCI formats of DCI type #B2 among the plurality of DCI formats.

DCI type #B1 may refer to a DCI format which requires a single HARQ-ACK information bit, and DCI type #B2 may refer to a DCI format which requires more than one HARQ-ACK information bit. The methods for determining the unified number O as described above may be applied to DCI type #B2. That is, for each DCI format of DCI type #B2, a unified number (e.g., O) of HARQ-ACK information bits is included in the HARQ-ACK codebook. The DAIs of the DCI formats of DCI type #B1 are counted independently from the DAIs of the DCI formats of DCI type #B2. The number of transmitted DCI type #B1 and the number of transmitted DCI type #B2 may be separately determined based on the respective total DAI in the CA case or respective counter DAI in the single carrier case.

In some examples, DCI type #B1 may include the following DCI formats:
A fallback DCI format, e.g., DCI format 1_0.
In some examples, DCI format 1_0 is only included in DCI type #B1, regardless of whether the DCI format 1_0 is transmitted on a carrier configured with CBG-based (re) transmission or not, the DCI format 1_0 is be transmitted on a carrier configured with a TDRA table containing at least one entry indicating a plurality of SLIVs or configured with a TDRA table with each entry indicating a single SLIV, the DCI format 1_0 is transmitted on a carrier configured with multi-carrier PDSCH scheduling via a single DCI, and the DCI format 1_0 is transmitted for SPS PDSCH release or secondary cell (SCell) dormancy without scheduled PDSCH.
A non-fallback DCI format (e.g., DCI format 1_1 or DCI format 1_2), which is transmitted on a carrier not configured with CBG-based (re) transmission, and furthermore, the carrier may be configured with a TDRA table with each entry indicating a SLIV;
   the carrier may be configured with a TDRA table with at least one entry indicating a plurality of SLIVs and a single PDSCH is scheduled by the non-fallback DCI format;
   a plurality of PDSCHs on a plurality of carriers may be schedulable by the non-fallback DCI and a single PDSCH is scheduled by the non-fallback DCI format;
   a single PDSCH is schedulable by the non-fallback DCI format; or
   the carrier may be configured with a maximum of two TBs per PDSCH and spatial bundling is applied.

In some examples, DCI type #B2 may include the following DCI formats:
a non-fallback DCI format (e.g., DCI format 1_1 or DCI format 1_2), wherein the non-fallback DCI format:
   is transmitted on a carrier configured with CBG based (re) transmission, or a carrier configured with a TDRA table with at least one entry indicating a plurality of SLIV and at least two PDSCHs are scheduled by the non-fallback DCI format, or a carrier configured with a maximum of two TBs per PDSCH and no spatial bundling is applied; or
   schedules at least two PDSCHs on at least one carrier.

The HARQ-ACK codebook may include two sub-codebooks, one (e.g., sub-codebook #B1) including HARQ-ACK information bits for DCI formats in DCI set #B1 and another (e.g., sub-codebook #B2) including HARQ-ACK information bits for DCI formats in DCI set #B2. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set. In sub-codebook #B2, every O HARQ-ACK information bits may correspond to a corresponding DCI format of DCI type #B2.

The two sub-codebooks may be arranged according to a predefined manner in the HARQ-ACK codebook. For example, sub-codebook #B1 may be placed in front of sub-codebook #B2 in the HARQ-ACK codebook. For example, sub-codebook #B2 may be placed in front of sub-codebook #B1 in the HARQ-ACK codebook.

In one embodiment, the UE may not expect that the CBG-based (re) transmission is configured simultaneously with multiple PDSCHs scheduled by a single DCI in the same cell group. For example, the BS may not configure the CBG-based (re) transmission simultaneously with multiple PDSCHs scheduled by a single DCI in the same cell group to the UE.

In another embodiment, a UE may be configured with CBG-based (re) transmission simultaneously with multiple PDSCHs scheduled by a single DCI format in the same cell group. When the number of actually scheduled PDSCHs by a single DCI format is equal to one, the UE applies CBG-based HARQ-ACK feedback for the TB carried by the actually scheduled PDSCH. When the number of actually scheduled PDSCHs by the single DCI format is larger than one, the UE applies TB-based HARQ-ACK feedback for the PDSCHs scheduled by the single DCI format. The scheduled PDSCHs may be in different slots on the same carrier, or on different carriers.

For example, referring back to FIG. 3, DCI format #A1 in PDCCH 311 may schedule PDSCH transmission 3201 on carrier 331, and require one HARQ-ACK information bit. DCI format #A2 in PDCCH 312 may schedule a plurality of PDSCH transmissions, for example, PDSCH transmission 3202 on carrier 332, PDSCH transmission 3203 on carrier 333, and PDSCH transmission 3204 on carrier 334, and require three HARQ-ACK information bits. DCI format #A3 in PDCCH 313 may schedule a plurality of PDSCH transmissions, for example, PDSCH transmission 3205 on carrier 335, PDSCH transmission 3206 on carrier 335, and PDSCH transmission 3207 on carrier 335, and require three HARQ-ACK information bits. DCI format #A4 in PDCCH 314 may schedule PDSCH transmission 3208 on carrier 336 with CBG-based (re) transmission. DCI format #A5 in PDCCH 315 may schedule PDSCH transmission 3209 on carrier 331, and require one HARQ-ACK information bit. DCI format #A6 in PDCCH 316 may schedule PDSCH transmission 3210 on carrier 332, and require one HARQ-ACK information bit.

FIG. 4B illustrates exemplary HARQ-ACK codebook determination in accordance with some embodiments of the present disclosure. For example, a HARQ-ACK codebook (not shown in FIG. 4B) may include HARQ-ACK information bits for PDSCHs scheduled by DCI formats #A1-#A6 in FIG. 3, and may be transmitted in PUCCH 432.

Based on the definitions of DCI type #B1 and DCI type #B2, the UE may divide the plurality of DCI formats into two sets, for example, DCI set 460-B1, which includes DCI format #A1, DCI format #A5, and DCI format #A6, and DCI set 460-B2, which includes DCI format #A2, DCI format #A3, and DCI format #A4. DAIs are counted separately in the two sets. Combined with the definitions of the counter DAI and total DAI, the counter DAI and total DAI indicated by each DCI format (i.e., DCI format #A1-#A6) are presented in the following table.

TABLE 2

| DCI format | counter DAI | total DAI |
|---|---|---|
| DCI format #A1 in PDCCH 311 | 1 | 1 |
| DCI format #A2 in PDCCH 312 | 1 | 3 |
| DCI format #A3 in PDCCH 313 | 2 | 3 |
| DCI format #A4 in PDCCH 314 | 3 | 3 |
| DCI format #A5 in PDCCH 315 | 2 | 3 |
| DCI format #A6 in PDCCH 316 | 3 | 3 |

The UE may generate a single HARQ-ACK information bit for each DCI format (e.g., DCI format #A1, DCI format #A5, and DCI format #A6) in DCI set 460-B1 in a sub-codebook (e.g., sub-codebook 450-B1).

The UE may generate a unified number of HARQ-ACK information bits for each DCI format in DCI set 460-B2 in another sub-codebook (e.g., sub-codebook 450-B2). The unified number may be predefined, determined based on an explicit configuration, or determined based on an implicit rule. For example, the UE may determine the unified number of HARQ-ACK information bits for each DCI format in DCI format set 460-B2 with the above-mentioned options A1-A3.

In each sub-codebook, the HARQ-ACK information bits per DCI format may be arranged according to the DAIs, for example, in a predefined order (e.g., an ascending order or a descending order) of the counter DAIs.

The two HARQ-ACK sub-codebooks may be concatenated in a predefined order, for example, HARQ-ACK sub-codebook 450-B1 may be placed firstly in the HARQ-ACK codebook and HARQ-ACK sub-codebook 450-B2 may follow HARQ-ACK sub-codebook 450-B1; or vice versa.

In some embodiments, the UE may be configured with CBG-based (re) transmission simultaneously with multiple PDSCHs schedulable by a single DCI format.

For example, when the number of actually scheduled PDSCHs by a DCI format is one, the DCI format may include a CBG transmission information (CBGTI) field. The CBGTI may be a bitmap with each bit corresponding to one CBG so that the length of the CBGTI is equal to an RRC configured maximum number of CBGs per TB. A bit value of ‘0’ in the CBGTI field may indicate that the corresponding CBG is not to be transmitted, and a bit value of ‘l’ may indicate that it is to be transmitted, or vice versa. The UE may apply CBG-based HARQ-ACK feedback for the TB carried by the actually scheduled PDSCH. For example, the number of the CBG-based HARQ-ACK feedback bits may be equal to the configured maximum number of CBGs per TB.

When the number of actually scheduled PDSCHs is larger than one, the DCI format may not include the CBGTI field. The UE may apply TB-based HARQ-ACK feedback for the PDSCHs scheduled by the DCI format. For example, the number of the HARQ-ACK feedback bits for the PDSCHs scheduled by the DCI format may be equal to the maximum number of PDSCHs schedulable by a single DCI format.

For instance, it is assumed that the unified number of HARQ-ACK information bits for DCI type #B2 may be equal to 4. HARQ-ACK sub-codebook 450-B1 may include HARQ-ACK information bits {c1, c2, c3}, and HARQ-ACK sub-codebook 450-B2 may include HARQ-ACK information bits {d1, d2, d3, d4, d5, d6, d7, d8, d9, d10, d11, d12}, where
c1, c2, and c3 are the HARQ-ACK information bits for DCI format #A1, DCI format #A5, and DCI format #A6.
d1, d2, d3, and d4 are the HARQ-ACK information bits for PDSCH 3202, PDSCH 3203 and PDSCH 3204 scheduled by DCI format #A2. For example, d1 may be the HARQ-ACK information bit for PDSCH 3202, d2 may be the HARQ-ACK information bit for PDSCH 3203, and d3 may be the HARQ-ACK information bit for PDSCH 3204, and d4 may be a NACK bit for aligning the size of HARQ-ACK information bits for PDSCHs scheduled by DCI format #A2 to the unified number.
d5, d6, d7, and d8 are the HARQ-ACK information bits for PDSCH 3205, PDSCH 3206 and PDSCH 3207 scheduled by DCI format #A3. For example, d5 may be the HARQ-ACK information bit for PDSCH 3205, d6 is the HARQ-ACK information bit for PDSCH 3206, and d7 may be the HARQ-ACK information bit for PDSCH 3207, and d8 may be a NACK bit for aligning the size of HARQ-ACK information bits for PDSCHs scheduled by DCI format #A3 to the unified number.
d9, d10, d11, and d12 are the HARQ-ACK information bits for PDSCH 3208 scheduled by DCI format #A4. Assuming that for the TB on PDSCH 3208 comprises 4 CBGs, d9, d10, d11, and d12 may correspond to the 4 CBG-level HARQ-ACK bits with each bit corresponding to one corresponding CBG. No bundling or padding operation is needed. If the TB on PDSCH 3208 comprises more than 4 CBGs, HARQ-ACK bundling among the CBG-level HARQ-ACK bits is performed. If the TB on PDSCH 3208 comprises less than 4 CBGs, a NACK bit(s) may be added until the total HARQ-ACK bits for PDSCH 3208 is 4. That is, a bundling or padding operation may be performed to align the size of actual HARQ-ACK information bits for PDSCHs scheduled by DCI format #A4 to the unified number.

In some embodiments, the plurality of DCI formats may be divided into three sets (e.g., DCI set #C1, DCI set #C2, and DCI set #C3). DCI set #C1 may include DCI formats of DCI type #C1 among the plurality of DCI formats. DCI set #C2 may include DCI formats of DCI type #C2 among the plurality of DCI formats. DCI set #C3 may include DCI formats of DCI type #C3 among the plurality of DCI formats.

In some examples, the definition of DCI type #C1 is similar to that of DCI type #B1, therefore the details are omitted here.

DCI type #C2 may refer to a DCI format which schedules two or more PDSCHs on at least one carrier. For example, the two or more PDSCHs may be scheduled on the same carrier, or on different carriers with each carrier carrying only one PDSCH, or on different carriers with each carrier carrying one or more PDSCHs.

For example, DCI type #C2 may include a non-fallback DCI format (e.g., a DCI format 1_1 or a DCI format 1_2) which is transmitted on a carrier configured with a TDRA table with at least one entry indicating a plurality of SLIVs and at least two PDSCHs are scheduled by the non-fallback DCI format, or a non-fallback DCI which schedules at least two PDSCHs on at least one carrier.

For DCI type #C2, the number of HARQ-ACK information bits for the multiple PDSCHs scheduled by DCI type #C2 is based on M, i.e., the configured maximum number of PDSCHs schedulable by a DCI format. For example, for each DCI format of DCI type #C2, a unified number (e.g., M1) of HARQ-ACK information bits is included in the HARQ-ACK codebook. In some examples, M1=M.

DCI type #C3 may refer to a DCI format which schedules a single PDSCH with CBG-level HARQ-ACK feedback. For example, DCI type #C3 may include a non-fallback DCI format (e.g., a DCI format 1_1 or a DCI format 1_2) that schedules a single PDSCH and is transmitted on a carrier configured with a CBG based (re) transmission.

For DCI type #C3, the number of HARQ-ACK information bits for the scheduled PDSCH scheduled by DCI type #C3 is based on N, i.e., the configured maximum number of CBGs per TB. For example, for each DCI format of DCI type #C3, a unified number (e.g., N1) of HARQ-ACK information bits is included in the HARQ-ACK codebook. In some examples, N1=N.

In some embodiments, the HARQ-ACK codebook may include three sub-codebooks, the first (e.g., sub-codebook #C1) including HARQ-ACK information bits for DCI formats in DCI set #C1, the second (e.g., sub-codebook #C2) including HARQ-ACK information bits for DCI formats in DCI set #C2, and the third (e.g., sub-codebook #C3) including HARQ-ACK information bits for DCI formats in DCI set #C3. The DAIs of the DCI formats of different types (e.g., DCI type #C1, DCI type #C2, DCI type #C3) or in different DCI sets are counted independently. The number of transmitted DCI type #C1, the number of transmitted DCI type #C2, and the number of transmitted DCI type #C3 may be separately determined based on the respective total DAIs in the CA case or respective counter DAI in the single carrier case.

In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set. For example, in sub-codebook #C2, every M1 HARQ-ACK information bits may correspond to a corresponding DCI format of DCI type #C2. In sub-codebook #C3, every N1 HARQ-ACK information bits may correspond to a corresponding DCI format of DCI type #C3.

In some other embodiments, the presence of sub-codebook #C2 or sub-codebook #C3 may be dependent on the value of M1 and N1, for example, dependent on whether M1 is equals N1 or not.

For example, in the case that M1/N1, sub-codebook #C2 and sub-codebook #C3 are present. The DAIs of the DCI formats of the above three DCI types, i.e. DCI type #C1, DCI type #C2, DCI type #C3 are counted independently.

In the case that M1=N1, DCI format set #C3 and sub-codebook #C3 are not present. DCI format set #C2 includes DCI formats of DCI type #C2 and DCI type #C3. The DAIs of the DCI formats of DCI type #C2 are counted together with those of DCI type #C3, but independently from those of DCI type #C1. Sub-codebook #C2 includes HARQ-ACK information bits for DCI formats in DCI format set #C2. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set.

In the case that three sub-codebooks are generated, the three sub-codebooks may be arranged according to a predefined manner in the HARQ-ACK codebook. For example, the three sub-codebooks may be ordered by any one of the following orders (supposing all three sub-codebooks are included) or the like:
sub-codebook #C1, sub-codebook #C2, sub-codebook #C3;
sub-codebook #C1, sub-codebook #C3, sub-codebook #C2;
sub-codebook #C2, sub-codebook #C1, sub-codebook #C3;
sub-codebook #C2, sub-codebook #C3, sub-codebook #C1;
sub-codebook #C3, sub-codebook #C1, sub-codebook #C2; or
sub-codebook #C3, sub-codebook #C2, sub-codebook #C1.

In the case that two sub-codebooks are generated, the two sub-codebooks may be arranged according to a predefined manner in the HARQ-ACK codebook. For example, the two sub-codebooks may be ordered by any one of the following orders or the like:
sub-codebook #C1, sub-codebook #C2; or
sub-codebook #C2, sub-codebook #C1.

The UE may concatenate the sub-codebooks by any of the above orders, and generate the HARQ-ACK codebook including the above HARQ-ACK sub-codebooks.

In some embodiments, the UE may be configured with CBG-based (re) transmission simultaneously with multiple PDSCHs schedulable by a single DCI format.

For example, when the number of actually scheduled PDSCHs by a DCI format is one, the DCI format may include a CBGTI field. The UE may apply CBG-based HARQ-ACK feedback for the TB carried by the actually scheduled PDSCH. For example, the number of the CBG-based HARQ-ACK feedback bits may be equal to the configured maximum number of CBGs per TB.

When the number of actually scheduled PDSCHs is larger than one, the DCI format may not include the CBGTI field. The UE may apply TB-based HARQ-ACK feedback for the PDSCHs scheduled by the DCI format. For example, the number of the HARQ-ACK feedback bits for the PDSCHs scheduled by the DCI format may be equal to the maximum number of PDSCHs schedulable by a single DCI format.

FIG. 4C illustrates exemplary HARQ-ACK codebook determination in accordance with some embodiments of the present disclosure. For example, HARQ-ACK codebook (not shown in FIG. 4C) may include HARQ-ACK information bits for PDSCHs scheduled by DCI formats #A1-#A6 in FIG. 3, and may be transmitted in PUCCH 433.

For example, based on the definitions of DCI type #C1, DCI type #C2, and DCI type #C3, the UE may divide DCI formats #A1-#A6 into three DCI format sets (e.g., DCI format set 460-C1, DCI format set 460-C2, and DCI format set 460-C3). For example, DCI format set 460-C1 includes DCI format #A1, DCI format #A5, and DCI format #A6; DCI format set 460-C2 includes DCI format #A2, and DCI format #A3; and DCI format set 460-C3 includes DCI format #A4. The UE may further generate three sub-codebooks (e.g., HARQ-ACK sub-codebook 450-C1, HARQ-ACK sub-codebook 450-C2, and HARQ-ACK sub-codebook 450-C3) corresponding to each DCI format set.

DAIs are counted separately in the three DCI format sets. Combined with the definitions of the counter DAI and total DAI, and the counter DAI and total DAI indicated by each DCI format (i.e., DCI format #A1-#A6) are presented in the following table.

TABLE 3

| DCI format | counter DAI | total DAI |
|---|---|---|
| DCI format #A1 in PDCCH 311 | 1 | 1 |
| DCI format #A2 in PDCCH 312 | 1 | 2 |
| DCI format #A3 in PDCCH 313 | 2 | 2 |
| DCI format #A4 in PDCCH 314 | 1 | 1 |
| DCI format #A5 in PDCCH 315 | 2 | 3 |
| DCI format #A6 in PDCCH 316 | 3 | 3 |

For each DCI format in DCI format set 460-C1, the number of HARQ-ACK information bits is 1. For each DCI format in DCI format set 460-C2, the number of HARQ-ACK information bits for each DCI format #C2 is M1. For each DCI format in DCI format set 460-C3, the number of HARQ-ACK information bits for each DCI format #C3 is N1.

Assuming that M1=4 and N1=6, HARQ-ACK sub-codebook 450-C1 may include {e1, e2, e3}, HARQ-ACK sub-codebook 450-C2 may include {f1, f2, f3, f4, f5, f6, f7, f8}, and HARQ-ACK sub-codebook 450-C3 may include {g1, g2, g3, g4, g5, g6}, where
e1, e2, and e3 are the HARQ-ACK information bits for DCI format #A1, DCI format #A5, and DCI format #A6.
f1, f2, f3, and f4 are the HARQ-ACK information bits for DCI format #A2.
f5, f6, f7, and f8 are the HARQ-ACK information bits for DCI format #A3.
g1, g2, g3, g4, g5, and g6 are HARQ-ACK information bits for DCI format #A4.

Size alignment may be performed on the HARQ-ACK information bits to obtain the above HARQ-ACK information bits.

In some embodiments, the plurality of DCI formats may be divided into four sets (e.g., DCI set #D1, DCI set #D2, DCI set #D3, and DCI set #D4). DCI set #D1 may include DCI formats of DCI type #D1 among the plurality of DCI formats, DCI set #D2 may include DCI formats of DCI type #D2 among the plurality of DCI formats, DCI set #D3 may include DCI formats of DCI type #D3 among the plurality of DCI formats, and DCI set #D4 may include DCI formats of DCI type #D4 among the plurality of DCI formats.

In some examples, the definition of DCI type #D1 is similar to that of DCI type #B1, therefore the details are omitted here.

DCI type #D2 may refer to a DCI format which schedules two or more PDSCHs on the same carrier (i.e., the same serving cell). For example, DCI type #D2 may include a non-fallback DCI format (e.g., a DCI format 1_1 or a DCI format 1_2) transmitted on a carrier configured with a TDRA table with at least one entry indicating a plurality of SLIVs and at least two PDSCHs are scheduled on the same carrier by the non-fallback DCI format. The number of HARQ-ACK information bits (e.g., A1) for the multiple PDSCHs scheduled by a DCI format of DCI type #D2 is based on A, i.e., the configured maximum number of PDSCHs on a same serving cell which can be scheduled by a DCI format. In some embodiments, A1=A.

DCI type #D3 may refer to a DCI format which schedules two or more PDSCHs on multiple carriers (i.e., multiple serving cells) with each carrier carrying one or more PDSCHs. For example, DCI type #D3 may include a non-fallback DCI format (e.g., a DCI format 1_1 or a DCI format 1_2) transmitted on a carrier configured with multi-carrier PDSCH scheduling via the non-fallback DCI format and at least two PDSCHs on two carriers are scheduled by the non-fallback DCI format. The number of HARQ-ACK information bits (e.g., B1) for the multiple PDSCHs scheduled by a DCI format of DCI type #D3 is based on B. i.e., the configured maximum number of PDSCHs which can be scheduled on multiple serving cells by a DCI format. In some embodiments, B1=B.

In some examples, the definition of DCI type #D4 is similar to that of DCI type #C3, therefore the details are omitted here. For clarify, the number of HARQ-ACK information bits for the PDSCH scheduled by a DCI format of DCI type #D4 is denoted as N2. In some embodiments, N2=N.

In one embodiment, the UE may always divide the received multiple DCI formats into the above four DCI format sets. The HARQ-ACK codebook may include four sub-codebooks, the first (e.g., sub-codebook #D1) including HARQ-ACK information bits for DCI formats in DCI set #D1, the second (e.g., sub-codebook #D2) including HARQ-ACK information bits for DCI formats in DCI set #D2, the third (e.g., sub-codebook #D3) including HARQ-ACK information bits for DCI formats in DCI set #D3, and the fourth (e.g., sub-codebook #D4) including HARQ-ACK information bits for DCI formats in DCI set #D4. The DAIs of the DCI formats of different types (e.g., DCI type #D1, DCI type #D2, DCI type #D3, and DCI type #D4) or in different DCI sets are counted independently from each other. The number of transmitted DCI type #D1, the number of transmitted DCI type #D2, the number of transmitted DCI type #D3, and the number of transmitted DCI type #D4 may be separately determined based on the respective total DAIs in the CA case or respective counter DAI in the single carrier case.

In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set. For example, in sub-codebook #D2, every A1 HARQ-ACK information bits may correspond to a corresponding DCI format of DCI type #D2. In sub-codebook #D3, every B1 HARQ-ACK information bits may correspond to a corresponding DCI format of DCI type #D3. In sub-codebook #D4, every N2 HARQ-ACK information bits may correspond to a corresponding DCI format of DCI type #D4.

In some other embodiments, the presence of sub-codebook #D2, sub-codebook #D3, or sub-codebook #D4 may be dependent on the value of A1, B1 and N2. For example, the relationship of the parameters, the corresponding DCI format sets, and the corresponding sub-codebook is represented in the following table:

TABLE 4

| | | DCI set #D1 | DCI set #D2 | DCI set #D3 | DCI set #D4 |
|---|---|---|---|---|---|
| | | sub-codebook | sub-codebook | sub-codebook | sub-codebook |
| | | #D1 including | #D2 including | #D3 including | #D4 including |
| | | HARQ-ACI | HARQ-ACI | HARQ-ACI | HARQ-ACI |
| | | information | information | information | information |
| Index | parameters | bits for | bits for | bits for | bits for |
| 1 | A1 = B1 = N2 | DCI type #D1 | DCI type | Not present | Not present |
| | | | #D2, DCI | | |
| | | | type #D3, and | | |
| | | | DCI type #D4 | | |
| 2 | A1 = B1 ≠ N2 | DCI type #D1 | DCI type #D2 | DCI type #D4 | Not present |
| | | | and DCI type | | |
| | | | #D3 | | |
| 3 | A1 ≠ B1 = N2 | DCI type #D1 | DCI type #D2 | DCI type #D3 | Not present |
| | | | | and DCI type | |
| | | | | #D4 | |
| 4 | A1 = N2 ≠ B1 | DCI type #D1 | DCI type #D2 | DCI type #D3 | Not present |
| | | | and DCI type | | |
| | | | #D4 | | |
| 5 | A1 ≠ B1 ≠ N2 | DCI type #D1 | DCI type #D2 | DCI type #D3 | DCI type #D4 |

For all the indexes, DCI format set #D1 includes all DCI formats of DCI type #D1. The UE generates HARQ-ACK sub-codebook #D1, which includes the HARQ-ACK information bits for each DCI format of DCI type #D1. The DAIs of the DCI formats of DCI type #D1 is counted independently from those of the DCI formats of other different DCI type(s). For example, the DAIs of the DCI formats of DCI type #D1 is only counted among DCI formats in DCI format set #D1.

For index 1 where A1=B1=N2, the number of HARQ-ACK information bits for DCI formats of DCI type #D2, DCI type #D3, and DCI type #D4 are the same. In this case, DCI format set #D3 and DCI format set #D4 are not present, and DCI format set #D2 includes DCI formats of DCI type #D2, DCI type #D3, and DCI type #D4. Correspondingly, sub-codebook #D3 and sub-codebook #D4 are not present, and HARQ-ACK sub-codebook #D2 includes the HARQ-ACK information bits for each DCI format of DCI type #D2, each DCI format of DCI type #D3, and each DCI format of DCI type #D4. The HARQ-ACK codebook includes HARQ-ACK sub-codebook #D1 and HARQ-ACK sub-codebook #D2. The DAIs of the DCI formats of DCI type #D1, the DAIs of the DCI formats of DCI type #D2, and DAIs of the DCI formats of DCI type #D3 are counted together, but independently from those of DCI type #D1. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set.

For index 2 where A1=B1 #N2, the number of HARQ-ACK information bits for DCI formats of DCI type #D2 and of DCI type #D3 are the same, and are different from the number of HARQ-ACK information bits for a DCI format of DCI type #D4. In this case, DCI format set #D4 is not present, DCI format set #D2 includes DCI formats of DCI type #D2 and DCI type #D3, and DCI format set #D3 includes DCI formats of DCI type #D4. Correspondingly, HARQ-ACK sub-codebook #D4 is not present. The UE generates HARQ-ACK sub-codebook #D2, which includes the HARQ-ACK information bits for each DCI format of DCI type #D2 and each DCI format of DCI type #D3. The UE generates HARQ-ACK sub-codebook #D3, which includes the HARQ-ACK information bits for each DCI format of DCI type #D4. The HARQ-ACK codebook includes HARQ-ACK sub-codebook #D1, HARQ-ACK sub-codebook #D2, and HARQ-ACK sub-codebook #D3. The DAIs of the DCI formats of DCI type #D2 are counted together with those of DCI type #D3, but independently from those of DCI type #D1 and those of DCI type #D4. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set.

For index 3 where A1 #B1=N2, the number of HARQ-ACK information bits for DCI formats of DCI type #D3 in DCI format set #D3, and each DCI format of DCI type #D4 in DCI format set #D4, are the same, and the number of HARQ-ACK information bits for each DCI format of DCI type #D2 in DCI format set #D2 is different. In this case, DCI format set #D4 is not present, DCI format set #D2 includes all DCI formats #D2, and DCI format set #D3 includes all DCI formats #D3 and all DCI formats #D4. Correspondingly, HARQ-ACK sub-codebook #D4 is not present, the UE generates HARQ-ACK sub-codebook #D2, which includes the HARQ-ACK information bits for each DCI format of DCI type #D2, and generates HARQ-ACK sub-codebook #D3, which includes the HARQ-ACK information bits for each DCI format of DCI type #D3 and each DCI format of DCI type #D4. The HARQ-ACK codebook includes HARQ-ACK sub-codebook #D1, HARQ-ACK sub-codebook #D2, and HARQ-ACK sub-codebook #D3. The DAIs of the DCI formats of DCI type #D3 are counted together with those of DCI type #D4, but independently from those of DCI type #D1 and those of DCI type #D2. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set.

For index 4, A1=N2 #B1, the number of HARQ-ACK information bits for DCI formats of DCI type #D2 and DCI type #D4are the same, and are different from the number of HARQ-ACK information bits for a DCI format of DCI type #D3. In this case, DCI format set #D4 is not present, DCI format set #D2 includes DCI formats of DCI type #D2 and DCI type #D4, and DCI format set #D3 includes DCI formats of DCI type #D3. Correspondingly, HARQ-ACK sub-codebook #D4 is not present. The UE generates HARQ-ACK sub-codebook #D2, which includes the HARQ-ACK information bits for each DCI format of DCI type #D2 and each DCI format of DCI type #D4. The UE generates HARQ-ACK sub-codebook #D3, which includes the HARQ-ACK information bits for each DCI format of DCI type #D3. The HARQ-ACK codebook includes HARQ-ACK sub-codebook #D1, HARQ-ACK sub-codebook #D2, and HARQ-ACK sub-codebook #D3. The DAIs of the DCI formats of DCI type #D2 are counted together with those of DCI type #D4, but independently from those of DCI type #D1 and those of DCI type #D3. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set.

For index 5 where A1 #B1 #N2, the number of HARQ-ACK information bits for each DCI format of DCI type #D2, the number of HARQ-ACK information bits for each DCI format of DCI type #D3, and the number of HARQ-ACK information bits for each DCI format of DCI type #D4 are different from each other. In this case, DCI format set #D2 includes all DCI formats of DCI type #D2, DCI format set #D3 includes DCI formats of DCI type #D3, and DCI format set #D4 includes DCI formats of DCI type #D4. Correspondingly, the UE generates HARQ-ACK sub-codebook #D2, which includes the HARQ-ACK information bits for each DCI format of DCI type #D2. The UE generates HARQ-ACK sub-codebook #D3, which includes the HARQ-ACK information bits for each DCI format of DCI type #D3. The UE generates HARQ-ACK sub-codebook #D4, which includes the HARQ-ACK information bits for each DCI format of DCI type #D4. The HARQ-ACK codebook includes HARQ-ACK sub-codebook #D1, HARQ-ACK sub-codebook #D2, HARQ-ACK sub-codebook #D3, and HARQ-ACK sub-codebook #D4. The DAIs of the DCI formats of DCI type #D1, the DAIs of the DCI formats of DCI type #D2, the DAIs of the DCI formats of DCI type #D3, and the DAIs of the DCI formats of DCI type #D4 are all counted independently from each other. In each sub-codebook, the HARQ-ACK information bits for PDSCHs scheduled by respective DCI formats in the corresponding DCI set are arranged according to the DAIs (e.g., counter DAI) of the respective DCI formats in the corresponding DCI set.

After determining the HARQ-ACK sub-codebooks, the UE may concatenate the HARQ-ACK sub-codebooks in a predefined order to form the final HARQ-ACK codebook. For example, in the case that four sub-codebooks are generated, the orders may include:
sub-codebook #D1, sub-codebook #D2, sub-codebook #D3, sub-codebook #D4;
sub-codebook #D1, sub-codebook #D3, sub-codebook #D2, sub-codebook #D4;
sub-codebook #D2, sub-codebook #D1, sub-codebook #D3, sub-codebook #D4;
sub-codebook #D2, sub-codebook #D3, sub-codebook #D1, sub-codebook #D4; or
any other order of the sub-codebooks.

In the case that three sub-codebooks are generated, the HARQ-ACK codebook including three of sub-codebook #D1, sub-codebook #D2, sub-codebook #D3, and sub-codebook #D4 may be arranged in a similar fashion as the order for arranging the sub-codebook #C1, sub-codebook #C2, sub-codebook #C3. In the case that two sub-codebooks are generated, the HARQ-ACK codebook including two of sub-codebook #D1, sub-codebook #D2, sub-codebook #D3, and sub-codebook #D4 may be arranged in a similar fashion as the order for arranging the sub-codebook #B1 and sub-codebook #B2.

In some embodiments, the UE may be configured with CBG-based (re) transmission simultaneously with multiple PDSCHs schedulable by a single DCI format.

For example, when the number of actually scheduled PDSCHs by a DCI format is one, the DCI format may include a CBGTI field. The UE may apply CBG-based HARQ-ACK feedback for the TB carried by the actually scheduled PDSCH. For example, the number of the CBG-based HARQ-ACK feedback bits may be equal to the configured maximum number of CBGs per TB.

When the number of actually scheduled PDSCHs is larger than one, the DCI format may not include the CBGTI field. If the DCI format is of DCI type #D2, the UE may generate A1 or A HARQ-ACK feedback bits for the PDSCHs scheduled by the DCI format. If the DCI format is of DCI type #D3, the UE may generate B1 or B HARQ-ACK feedback bits for the PDSCHs scheduled by the DCI format.

FIG. 4D illustrates exemplary HARQ-ACK codebook determination in accordance with some embodiments of the present disclosure. For example, HARQ-ACK codebook (not shown in FIG. 4D) may include HARQ-ACK information bits for PDSCHs scheduled by DCI formats #A1-#A6 in FIG. 3, and may be transmitted in PUCCH 434.

For example, based on the definitions of DCI type #D1, DCI type #D2, DCI type #D3, and DCI type #D4, the UE may divide DCI formats #A1-#A6 into four DCI format sets (e.g., DCI format set 460-D1, DCI format set 460-D2, DCI format set 460-D3, and DCI format set 460-D4). For example, DCI format set 460-D1 includes DCI format #A1, DCI format #A5, and DCI format #A6; DCI format set 460-D2 includes DCI format #A3; DCI format set 460-D3 includes DCI format #A2; and DCI format set 460-D4 includes DCI format #A4. The UE may further generate four sub-codebooks (e.g., HARQ-ACK sub-codebook 450-D1, HARQ-ACK sub-codebook 450-D2, HARQ-ACK sub-codebook 450-D3 and HARQ-ACK sub-codebook 450-D4) corresponding to each DCI format set.

DAIs are counted separately in the four sets. Combined with the definitions of the counter DAI and total DAI, and the counter DAI and total DAI indicated by each DCI format (i.e., DCI format #A1-#A6) are presented in the following table.

TABLE 5

| DCI format | counter DAI | total DAI |
|---|---|---|
| DCI format #A1 in PDCCH 311 | 1 | 1 |
| DCI format #A2 in PDCCH 312 | 1 | 1 |
| DCI format #A3 in PDCCH 313 | 1 | 1 |
| DCI format #A4 in PDCCH 314 | 1 | 1 |
| DCI format #A5 in PDCCH 315 | 2 | 3 |
| DCI format #A6 in PDCCH 316 | 3 | 3 |

For each DCI format in DCI format set 460-D1, the UE may generate HARQ-ACK sub-codebook 450-D1 which includes HARQ-ACK information bits {h1, h2, h3} corresponding to three PDSCHs (i.e., PDSCH 3201, PDSCH 3209 and PDSCH 3210) scheduled by DCI format #A1, DCI format #A5, and DCI format #A6.

For each DCI format in DCI format set 460-D2, the UE may generate HARQ-ACK sub-codebook 450-D2 which includes A1 bits (e.g., {i1, i2, i3, i4} assuming A1=4) corresponding to three PDSCHs (i.e., PDSCH 3205, PDSCH 3206 and PDSCH 3207) scheduled by DCI format #A3.

For each DCI format in DCI format set 460-D3, the UE may generate HARQ-ACK sub-codebook 450-D3 which includes B1 bits (e.g., {j1, j2, j3, j4, j5, j6} assuming B1=6) corresponding to three PDSCHs (i.e., PDSCH 3202, PDSCH 3203 and PDSCH 3204) scheduled by DCI format #A2.

For each DCI format in DCI format set 460-D4, the UE may generate HARQ-ACK sub-codebook 450-D4 which includes N2 bits (e.g., {k1, k2, k3, k4, k5, k6, k7, k8} assuming N2=8) corresponding to PDSCH 3208 scheduled by DCI format #A4.

In some examples, HARQ-ACK feedback for a SPS PDSCH is to be transmitted in the HARQ-ACK codebook described with respect to FIGS. 4B-4D. In some embodiments, the HARQ-ACK feedback for the SPS PDSCH may be placed at a predefined position (e.g., at the beginning or at the end) of the HARQ-ACK codebook. In some examples, the HARQ-ACK information bits for the SPS PDSCH in the HARQ-ACK codebook are the actual HARQ-ACK information bits for the SPS PDSCH. In some embodiments, the HARQ-ACK feedback for a SPS PDSCH may comprise a single HARQ-ACK information bit. The HARQ-ACK feedback for SPS PDSCH(s) may be placed at a predefined position (e.g., at the beginning or at the end) of the sub-codebook associated with a DCI type (e.g., DCI type #B1, DCI type #C1, or DCI type #D1) which requires a single HARQ-ACK information bit. In some embodiments, the SPS PDSCH may be transmitted on a carrier configured with CBG-(re) based transmission. The corresponding CBG-based HARQ-ACK information bits for the SPS PDSCH may be aligned with the determined unified number of HARQ-ACK information bits DCI type #B2, DCI type #C3, or DCI type #D4 and then be placed at a predefined position (e.g., at the beginning or at the end) of a sub-codebook associated with the corresponding DCI type (e.g., DCI type #B2. DCI type #C3, or DCI type #D4). For example, the HARQ-ACK feedback for the SPS PDSCH may be placed in sub-codebook #B2 or sub-codebook #C2, or one of sub-codebook #D2-sub-codebook #D4.

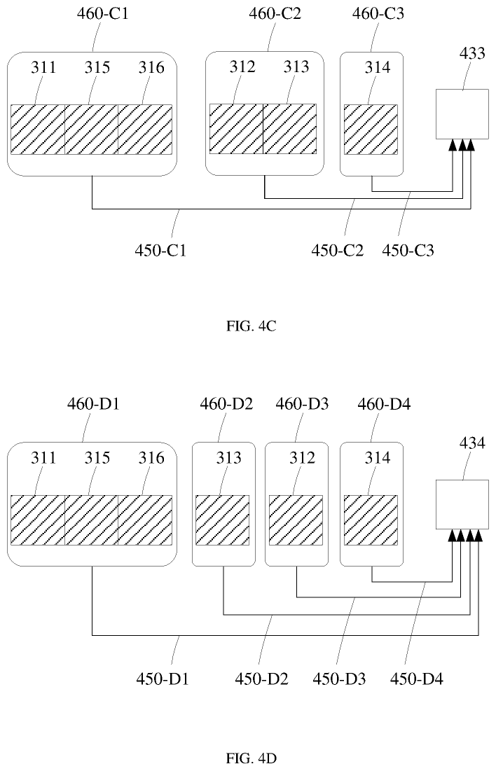

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 101 in FIG. 1.

In operation 511, the UE receives a plurality of DCI formats, wherein each of the plurality of DCI formats schedules one or more PDSCH transmissions on one or more carriers, and the plurality of DCI formats indicates a same slot for transmitting a HARQ-ACK codebook. For example, the UE receives DCI format #A1 to DCI format #A6 in FIG. 3.

In operation 513, the UE divides the plurality of DCI formats into at least two sets. A first set of the at least two sets may include all first type DCI formats of the plurality of DCI formats and a second set of the at least two sets may include all second type DCI formats of the plurality of DCI formats. Each first type DCI format requires a single HARQ-ACK information bit. Each second type DCI format requires more than one HARQ-ACK information bit. DAIs of the first type DCI formats are counted independently from those of the second type DCI formats. For example, the UE divides the plurality of DCI formats into at least two sets, i.e., DCI format set 460-B1 and DCI format set 460-B2 in FIG. 4B.

In operation 515, the UE generates a first HARQ-ACK sub-codebook comprising HARQ-ACK information bits for DCI formats in the first set. In operation 517, the UE generates a second HARQ-ACK sub-codebook comprising HARQ-ACK information bits for DCI formats in the second set. For example, the UE generates HARQ-ACK sub-codebook 450-B1 and HARQ-ACK sub-codebook 450-B2 in FIG. 4B. In operation 517, the UE transmits the HARQ-ACK codebook comprising the first HARQ-ACK sub-codebook and the second HARQ-ACK sub-codebook.

In some other embodiments of the present disclosure, each of the plurality of DCI formats may require a unified number of HARQ-ACK information bits (e.g., O). The UE may transmit a HARQ-ACK codebook comprising HARQ-ACK information bits corresponding to each of the plurality of DCI formats.

It should be appreciated by persons skilled in the art that the sequence of the operations in exemplary procedure 500 may be changed and some of the operations in exemplary procedure 500 may be eliminated or modified, without departing from the spirit and scope of the disclosure.

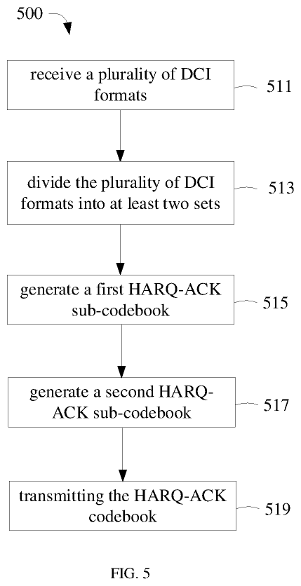

FIG. 6 illustrates a flow chart of an exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, BS 102 in FIG. 1.

In operation 611, the BS may transmit, to a UE, a plurality of DCI formats. Each of the plurality of DCI formats schedules one or more PDSCH transmissions on one or more carriers, and the plurality of DCI formats indicates a same slot for transmitting a HARQ-ACK codebook.

In operation 613, the BS may receive, from the UE, the HARQ-ACK codebook comprising a first HARQ-ACK sub-codebook and a second HARQ-ACK sub-codebook. In some examples, the plurality of DCI formats include at least two sets. A first set of the at least two sets comprises all first type DCI formats of the plurality of DCI formats and a second set of the at least two sets comprises all second type DCI formats of the plurality of DCI formats. Each first type DCI format requires a single HARQ-ACK information bit. Each second type DCI format requires more than one HARQ-ACK information bit. DAIs of the first type DCI formats are counted independently from those of the second type DCI formats. The first HARQ-ACK sub-codebook comprises HARQ-ACK information bits for DCI formats in the first set. The second HARQ-ACK sub-codebook comprises HARQ-ACK information bits for DCI formats in the second set.

It should be appreciated by persons skilled in the art that the sequence of the operations in exemplary procedure 600 may be changed and some of the operations in exemplary procedure 600 may be eliminated or modified, without departing from the spirit and scope of the disclosure.

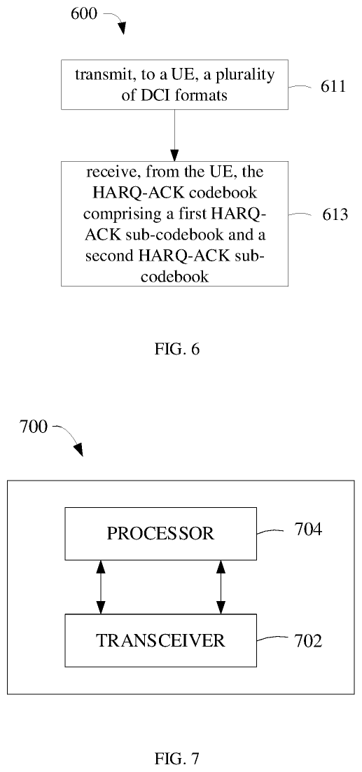

FIG. 7 illustrates a block diagram of an exemplary apparatus 700 according to some embodiments of the present disclosure. As shown in FIG. 7, the apparatus 700 may include at least one processor 704 and at least one transceiver 702 coupled to the processor 704. The apparatus 700 may be a UE or a BS.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations with respect to the UE described in FIGS. 1-6. In some embodiments of the present disclosure, the apparatus 700 may be a BS. The transceiver 702 and the processor 704 may interact with each other so as to perform the operations with respect to the BS described in FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement the method with respect to the UE as described above. For example, the computer-executable instructions, when executed, cause the processor 704 interacting with transceiver 702 to perform the operations with respect to the UE described in FIGS. 1-6.

In some embodiments of the present disclosure, the non-transitory computer-readable medium may have stored thereon computer-executable instructions to cause the processor 704 to implement the method with respect to the BS as described above. For example, the computer-executable instructions, when executed, cause the processor 704 interacting with transceiver 702 to perform the operations with respect to the BS described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a plurality of downlink control information (DCI) formats, wherein each of the plurality of DCI formats schedules one or more physical downlink shared channel (PDSCH) transmissions on one or more carriers, and the plurality of DCI formats indicates a same slot for transmitting a hybrid automatic repeat request acknowledge (HARQ-ACK) codebook;
divide the plurality of DCI formats into at least two sets, wherein a first set of the at least two sets comprises all first type DCI formats of the plurality of DCI formats and a second set of the at least two sets comprises all second type DCI formats of the plurality of DCI formats, wherein each first type DCI format requires a single HARQ-ACK information bit and each second type DCI format requires more than one HARQ-ACK information bit, and wherein downlink assignment indicators (DAIs) of the first type DCI formats are counted independently from those of the second type DCI formats;
generate a first HARQ-ACK sub-codebook comprising HARQ-ACK information bits for DCI formats in the first set;
generate a second HARQ-ACK sub-codebook comprising HARQ-ACK information bits for DCI formats in the second set; and
transmit the HARQ-ACK codebook comprising the first HARQ-ACK sub-codebook and the second HARQ-ACK sub-codebook.

2. The UE of claim 1, wherein the first type DCI format is from a group including one or more of:
a fallback DCI format; or
a non-fallback DCI format transmitted on a carrier not configured with a code block group (CBG) based transmission or retransmission, wherein:
the carrier is configured with a time domain resource allocation (TDRA) table with each entry indicating a single start and length indicator value (SLIV);
the carrier is configured with a TDRA table with at least one entry indicating a plurality of SLIVs and a single PDSCH is scheduled by the non-fallback DCI format;
a plurality of PDSCHs on a plurality of carriers is schedulable by the non-fallback DCI and a single PDSCH is scheduled by the non-fallback DCI format;
a single PDSCH is schedulable by the non-fallback DCI; or
the carrier is configured with a maximum of two transport blocks (TBs) per PDSCH and spatial bundling is applied.

3. The UE of claim 1, wherein the second type DCI format is from a group including one or more of:
a non-fallback DCI format transmitted on a carrier configured with code block group (CBG) based transmission or retransmission, or a carrier configured with a time domain resource allocation (TDRA) table with at least one entry indicating a plurality of start and length indicator values (SLIVs) and at least two PDSCHs are scheduled by the non-fallback DCI format, or a carrier configured with a maximum of two transport blocks (TBs) per PDSCH and no spatial bundling is applied; or
a non-fallback DCI which schedules at least two PDSCHs on at least one carrier.

4. The UE of claim 1, wherein to generate the second HARQ-ACK sub-codebook, the at least one processor is configured to cause the UE to:
generate HARQ-ACK information bits for a DCI format in the second set;
wherein in response to a number of PDSCHs scheduled by the DCI format being equal to 1, a number of the generated HARQ-ACK information bits for the DCI format is equal to a configured maximum number of code block groups (CBGs) per transport block (TB); or
wherein in response to the number of PDSCHs scheduled by the DCI format being greater than 1, the number of the generated HARQ-ACK information bits for the DCI format is equal to a configured maximum number of PDSCHs schedulable by a DCI format.

5. The UE of claim 1, wherein the at least one processor is further configured to cause the UE to determine a unified number of HARQ-ACK information bits per second type DCI format in the second set.

6. The UE of claim 5, wherein the unified number is configured by radio resource control (RRC) signaling; wherein the unified number is determined based on a configured maximum number of PDSCHs schedulable by a DCI format and a configured maximum number of code block groups (CBGs) per transport block (TB); or wherein the unified number is predefined.

7. The UE of claim 6, wherein to determine the unified number based on the configured maximum number of PDSCHs schedulable by a DCI format and the configured maximum number of CBGs per TB, the at least one processor is configured to cause the UE to determine that a value of the unified number is equal to a minimum value or a maximum value of the configured maximum number of PDSCHs schedulable by a DCI format and the configured maximum number of CBGs per TB.

8. The UE of claim 5, wherein to generate the second HARQ-ACK sub-codebook, the at least one processor is configured to cause the UE to:
generate HARQ-ACK information bits for a DCI format in the second set; and
in response to a number of the generated HARQ-ACK information bits for the DCI format being greater than the unified number, perform HARQ-ACK bundling to align the generated HARQ-ACK information bits with the unified number, or in response to the number of the generated HARQ-ACK information bits for the DCI format being less than the unified number, perform HARQ-ACK padding to align the generated HARQ-ACK information bits with the unified number.

9. The UE of claim 1, wherein the at least one processor is further configured to cause the UE to:
receive a semi-persistent scheduling (SPS) PDSCH; and
transmit HARQ-ACK feedback for the SPS PDSCH in the HARQ-ACK codebook,
wherein the HARQ-ACK feedback for the SPS PDSCH is placed at a predefined position of the first HARQ-ACK sub-codebook or the HARQ-ACK codebook; or
wherein the HARQ-ACK feedback for the SPS PDSCH is placed at a predefined position of the second HARQ-ACK sub-codebook with a number of bits of the HARQ-ACK feedback for the SPS PDSCH aligned with a unified number of HARQ-ACK information bits per second type DCI format in the second set.

10. A user equipment (UE) for wireless communication, comprising:
at least one memory; and
at least one processor coupled with the at least one memory and configured to cause the UE to:
receive a plurality of downlink control information (DCI) formats, wherein each of the plurality of DCI formats schedules one or more physical downlink shared channel (PDSCH) transmissions on one or more carriers, and the plurality of DCI formats indicates a same slot for transmitting a hybrid automatic repeat request acknowledge (HARQ-ACK) codebook, and wherein each of the plurality of DCI formats requires a unified number of HARQ-ACK information bits; and
transmit the HARQ-ACK codebook comprising HARQ-ACK information bits corresponding to each of the plurality of DCI formats.

11. The UE of claim 10, wherein downlink assignment indicators (DAIs) of the plurality of DCI formats are counted together and the HARQ-ACK information bits for the plurality of DCI formats are arranged according to the DAIs of the plurality of DCI formats.

12. The UE of claim 10, wherein the unified number is configured by radio resource control (RRC) signaling or determined based on a configured maximum number of PDSCHs schedulable by a DCI format and a configured maximum number of code block groups (CBGs) per transport block (TB); or wherein the unified number is predefined.

13. The UE of claim 10, wherein to generate the HARQ-ACK codebook, the at least one processor is further configured to cause the UE to:
generate HARQ-ACK information bits for a DCI format of the plurality of DCI formats;
in response to a number of the generated HARQ-ACK information bits for the DCI format being greater than the unified number, perform HARQ-ACK bundling to align the generated HARQ-ACK information bits with the unified number, or
in response to the number of the generated HARQ-ACK information bits for the DCI format being less than the unified number, perform HARQ-ACK padding to align the generated HARQ-ACK information bits with the unified number.

14. The UE of claim 10, wherein a first DCI format of the plurality of DCI formats schedules a plurality of PDSCHs in a plurality of time units on a single carrier, and HARQ-ACK information bits for the plurality of PDSCHs scheduled by the first DCI format are arranged according to the plurality of time units; or
wherein the first DCI format of the plurality of DCI formats schedules a plurality of PDSCHs on a plurality of carriers, and HARQ-ACK information bits for the plurality of PDSCHs scheduled by the first DCI format are arranged according to indexes of the plurality of carriers.

15. A base station for wireless communication, comprising:
at least one memory; and
at least one processor coupled with the at least one memory and configured to cause the base station to:
transmit, to a user equipment (UE), a plurality of downlink control information (DCI) formats, wherein each of the plurality of DCI formats schedules one or more physical downlink shared channel (PDSCH) transmissions on one or more carriers, and the plurality of DCI formats indicates a same slot for transmitting a hybrid automatic repeat request acknowledge (HARQ-ACK) codebook; and
receive, from the UE, the HARQ-ACK codebook comprising a first HARQ-ACK sub-codebook and a second HARQ-ACK sub-codebook,
wherein the plurality of DCI formats includes at least two sets, wherein a first set of the at least two sets comprises all first type DCI formats of the plurality of DCI formats and a second set of the at least two sets comprises all second type DCI formats of the plurality of DCI formats, wherein each first type DCI format requires a single HARQ-ACK information bit and each second type DCI format requires more than one HARQ-ACK information bit, and wherein downlink assignment indicators (DAIs) of the first type DCI formats are counted independently from those of the second type DCI formats;
wherein the first HARQ-ACK sub-codebook comprises HARQ-ACK information bits for DCI formats in the first set; and
wherein the second HARQ-ACK sub-codebook comprises HARQ-ACK information bits for DCI formats in the second set.

16. A processor for wireless communication, comprising:
at least one controller coupled with at least one memory and configured to cause the processor to:
receive a plurality of downlink control information (DCI) formats, wherein each of the plurality of DCI formats schedules one or more physical downlink shared channel (PDSCH) transmissions on one or more carriers, and the plurality of DCI formats indicates a same slot for transmitting a hybrid automatic repeat request acknowledge (HARQ-ACK) codebook;
divide the plurality of DCI formats into at least two sets, wherein a first set of the at least two sets comprises all first type DCI formats of the plurality of DCI formats and a second set of the at least two sets comprises all second type DCI formats of the plurality of DCI formats, wherein each first type DCI format requires a single HARQ-ACK information bit and each second type DCI format requires more than one HARQ-ACK information bit, and wherein downlink assignment indicators (DAIs) of the first type DCI formats are counted independently from those of the second type DCI formats;
generate a first HARQ-ACK sub-codebook comprising HARQ-ACK information bits for DCI formats in the first set;
generate a second HARQ-ACK sub-codebook comprising HARQ-ACK information bits for DCI formats in the second set; and
transmit the HARQ-ACK codebook comprising the first HARQ-ACK sub-codebook and the second HARQ-ACK sub-codebook.

17. The processor of claim 16, wherein the first type DCI format is from a group including one or more of:
a fallback DCI format; or
a non-fallback DCI format transmitted on a carrier not configured with a code block group (CBG) based transmission or retransmission, wherein:
the carrier is configured with a time domain resource allocation (TDRA) table with each entry indicating a single start and length indicator value (SLIV);
the carrier is configured with a TDRA table with at least one entry indicating a plurality of SLIVs and a single PDSCH is scheduled by the non-fallback DCI format;
a plurality of PDSCHs on a plurality of carriers is schedulable by the non-fallback DCI and a single PDSCH is scheduled by the non-fallback DCI format;
a single PDSCH is schedulable by the non-fallback DCI; or
the carrier is configured with a maximum of two transport blocks (TBs) per PDSCH and spatial bundling is applied.

18. The processor of claim 16, wherein the second type DCI format is from a group including one or more of:
a non-fallback DCI format transmitted on a carrier configured with code block group (CBG) based transmission or retransmission, or a carrier configured with a time domain resource allocation (TDRA) table with at least one entry indicating a plurality of start and length indicator values (SLIVs) and at least two PDSCHs are scheduled by the non-fallback DCI format, or a carrier configured with a maximum of two transport blocks (TBs) per PDSCH and no spatial bundling is applied; or
a non-fallback DCI which schedules at least two PDSCHs on at least one carrier.

19. The processor of claim 16, wherein to generate the second HARQ-ACK sub-codebook, the at least one controller is configured to cause the processor to:
generate HARQ-ACK information bits for a DCI format in the second set;
wherein in response to a number of PDSCHs scheduled by the DCI format being equal to 1, a number of the generated HARQ-ACK information bits for the DCI format is equal to a configured maximum number of code block groups (CBGs) per transport block (TB); or
wherein in response to the number of PDSCHs scheduled by the DCI format being greater than 1, the number of the generated HARQ-ACK information bits for the DCI format is equal to a configured maximum number of PDSCHs schedulable by a DCI format.

20. The processor of claim 16, wherein the at least one controller is further configured to cause the processor to determine a unified number of HARQ-ACK information bits per second type DCI format in the second set.
